(19) United States
(12) Patent Application Publication
(10) Pub. No.: US 2025/0116459 A1
(43) Pub. Date: Apr. 10, 2025

(54) FOOD WASTE DISPOSER

(71) Applicant: SAMSUNG ELECTRONICS CO., LTD., Suwon-si (KR)

(72) Inventors: Hyeonkyu LIM, Suwon-si (KR); Keonpyo KOO, Suwon-si (KR); Namsoo PARK, Suwon-si (KR)

(73) Assignee: SAMSUNG ELECTRONICS CO., LTD., Suwon-si (KR)

(21) Appl. No.: 18/987,250

(22) Filed: Dec. 19, 2024

Related U.S. Application Data
(63) Continuation of application No. PCT/KR2023/007132, filed on May 25, 2023.

(30) Foreign Application Priority Data
Jul. 6, 2022 (KR) 10-2022-0083390
Aug. 23, 2022 (KR) 10-2022-0105826

(51) Int. Cl. F26B 25/06; B09B 3/35; B09B 3/40; B09B 101/70; F26B 3/00

(52) U.S. Cl. CPC F26B 25/06; B09B 3/40; F26B 3/00; B09B 3/35; B09B 2101/70

(57) ABSTRACT

A food waste disposer comprises: a cover housing; a disposal device which is positioned in the cover housing to accommodate food waste; an exhaust pipe to be connected to the disposal device so as to guide moisture-containing air; a water storage container which may collect condensate water in the exhaust pipe and may be separated to the outside of the cover housing; a water storage housing to accommodate the water storage container; and a sensor module which comprises a water level sensor coupleable to the water storage housing, which based on the water level sensor being adjacent to the water storage container outputs a signal related to the water level of the condensate water collected in the water storage container, wherein the water level sensor detects the water level of the condensate water in the water storage container by making contact with the water storage container.

### CROSS-REFERENCE TO RELATED APPLICATION

This application is a continuation application, under 35 U.S.C. § 111 (a), of international application No. PCT/KR2023/007132, filed May 25, 2023, which claims priority under 35 U. S. C. § 119 to Korean Patent Application No. 10-2022-0083390, filed Jul. 6, 2022 and Korean Patent Application No. 10-2022-0105826, filed Aug. 23, 2022, the disclosures of which are incorporated herein by reference in their entireties.

### TECHNICAL FIELD

The present disclosure relates to a food waste disposer, and more particularly, to a food waste disposer including a water storage device configured to store condensate water generated during disposal of food waste.

### BACKGROUND ART

A food waste disposer is an apparatus for processing food waste by drying, stirring, and grinding the food waste.

The food waste disposer includes a disposer for drying, stirring and grinding food waste.

The food waste disposer is provided with an exhaust pipe that defines an exhaust path connected to a grinding device to discharge foul odors generated during a process of processing food waste to the outside.

Moisture in air passing through the exhaust path is condensed and liquefied as condensate water. The food waste disposer includes a water storage device including a water storage container to collect condensate water. To store condensate water in the water storage container, a water storage space is defined.

### DISCLOSURE

### Technical Problem

An aspect of the disclosure provides a food waste disposer that allows easy cleaning of a water storage container because the water storage container is detachable.

An aspect of the disclosure provides a food waste disposer with a water level sensor that does not impede a movement of a water storage container during a process of separating the water storage container to the outside.

An aspect of the disclosure provides a food waste disposer in which condensate water does not leak out of a water storage container during a process of separating the water storage container to the outside although a water level sensor is positioned inside a housing.

An aspect of the disclosure provides a food waste disposer configured to locate a water level sensor close to condensate water to be detected by the water level sensor.

An aspect of the disclosure provides a food waste disposer capable of indirectly pressing a water level sensor toward condensate water to prevent damage of the water level sensor.

An aspect of the disclosure provides a food waste disposer including a sensor module configured to easily accommodate a water level sensor therein.

Technical problems to be achieved by the present specification are not limited to the above-mentioned technical problems, and other technical problems not mentioned will be clearly understood by those skilled in the art to which the disclosure belongs from the following description.

### Technical Solution

To overcome the technical problems, a food waste disposer according to a concept of the disclosure may include a cover housing, a disposal device configured to accommodate food waste while positioned in the cover housing, an exhaust pipe connected to the disposal device and configured to guide air containing moisture, a water storage container configured to collect condensate water in the exhaust pipe, the water storage container being separable from the cover housing, and a sensor module including a water level sensor coupleable to the water storage housing while the water storage container is accommodated in the water storage housing, and while the sensor module is coupled to the water storage housing, the water level sensor is configured to output, based on the water level sensor being located adjacent to the water storage container, a signal related to the water level of the condensate water collected in the water storage container. While the water storage container is spaced from the sensor module, condensate water in the water storage container may be prevented from leaking out of the water storage container.

The water storage container may be movable between an accommodation position at which the water storage container is positioned inside the cover housing and is in contact with the sensor module, and a separation position at which the water storage container is positioned outside the cover housing and the water storage container is separated from the cover housing.

A water storage space to accommodate the condensate water may be defined in the water storage container, and the water level sensor may be, while the water storage container is located at the accommodation position, prevented from being located in the water storage space.

The water storage container may have an opposing container surface facing the sensor module while the water storage container is located at the accommodation position, and the sensor module may have an opposing module surface facing the opposing container surface and corresponding to the opposing container surface such that the sensor module is in close contact with the water storage container while the water storage container is located at the accommodation position.

The sensor module may further include a pressing member configured to press the water level sensor in a direction toward the water storage container while the water storage container is located at the accommodation position.

The sensor module may include a case in which the water level sensor is positioned, and the pressing member may be configured to indirectly press the water level sensor in the direction toward the water storage container by pressing the case while the water storage container is located at the accommodation position.

The food waste disposer may further include a water storage housing configured to accommodate the water storage container, and the sensor module may further include a first case in which the water level sensor is positioned, and a second case being coupleable to the water storage housing, wherein while the first case may be coupled to the second case, the first case is moveable forward and backward relative to the second case.

The pressing member may be positioned between the first case and the second case and configured to elastically support the first case in the direction toward the water storage container by being compressed while the water storage container is located at the accommodation position.

While the water storage container moves in an accommodation direction from the separation position toward the accommodation position, the first case may move to a position of the second case spaced in the accommodation direction from a position of the first case.

The first case may include a first part case having an opening in which the water level sensor is rested, and a second part case detachably coupled to the first part case and configured to prevent the water level sensor from being detached from the first part case.

The water storage housing may include a first opposing housing surface facing the water storage container while the water storage container is located at the accommodation position, and a second opposing housing surface which is opposite to the first opposing housing surface, and the second case may include a second case main body, a supporting flange portion bent from the second case main body and being in contact with the first opposing housing surface, and a supporting protrusion extending from the second case main body and supporting the second opposing housing surface.

A guide slit extending in a direction from the separation position of the water storage container toward the accommodation position may be defined in the second case, and the first case may include a slit protrusion of which at least a portion is accommodated in the guide slit to be guided by the guide slit.

The sensor module may further include a pressing damper positioned between the first case and the pressing member and configured to evenly distribute pressure applied to the first case by the pressing member.

The food waste disposer may further include a heating device configured to heat the disposal device to evaporate moisture of food waste accommodated in the disposal device, and an exhaust fan coupled to the exhaust pipe and configured to move air containing moisture in the disposal device to the exhaust pipe.

The water storage container may be positioned in a direction of gravity with respect to the exhaust pipe such that condensate water generated in the exhaust pipe is collected.

A food waste disposer according to a concept of the disclosure may include a cover housing, a disposal device positioned inside the cover housing, a heating device configured to heat the disposal device, an exhaust pipe to be connected to the disposal device, a water storage container configured to collect condensate water in the exhaust pipe and be movable from an accommodation position at which the water storage container is located inside the cover housing to a separation position at which the water storage container is located outside the cover housing, a water level sensor configured to output a signal related to a water level of condensate water collected in the water storage container while the water level sensor is located adjacent to the water storage container, and a pressing member configured to press the water level sensor in a direction toward the water storage container. While the water storage container is spaced from the water level sensor, condensate water in the water storage container may be prevented from leaking out of the water storage container.

The food waste disposer may further include a case configured to accommodate the water level sensor, and the pressing member may include a pressing motor, a gear coupled to a rotating shaft of the pressing motor, and a rack engaged with the gear and configured to press the case according to a rotation of the gear.

The water level sensor may be in contact with an outer surface of the water storage container, and output a signal related to a water level of condensate water in the water storage container according to a change in capacitance of the water storage container.

A water storage container hole may be defined in the water storage container, the water level sensor may protrude to be inserted into or taken out of the water storage container through the water storage container hole, and the food waste disposer may further include a valve case located inside the water storage container and located adjacent to the water storage container hole, a water storage container valve of which a movement is guided by the valve case, a valve elastic member positioned between the valve case and the water storage container valve in such a way as to be compressible, and a valve sealing member configured to seal between the water storage container hole and the water storage container valve.

A food waste disposer according to a concept of the disclosure may include a cover housing, a disposal device positioned inside the cover housing and configured to accommodate food waste to be processed, an exhaust pipe connected to the disposal device and configured to guide air containing moisture, a water storage container configured to collect condensate water in the exhaust pipe, and a water level sensor positioned inside the cover housing and configured to output, while the water level sensor is in contact with the water storage container, a signal related to a water level of condensate water collected in the water storage container.

### Advantageous Effects

According to an embodiment of the disclosure, a food waste disposer may include a water storage device connected to an exhaust path, wherein the water storage device detachably accommodates a water storage container such that the water storage container is detachable.

According to an embodiment of the disclosure, a food waste disposer may include a water level sensor that is prevented from contacting a water storage container while the water storage container moves in a separation direction, such that the movement of the water storage container is not impeded.

According to an embodiment of the disclosure, a food waste disposer may include a water level sensor capable of measuring a water level of condensate water by contacting an outer side of a water storage container although the water level sensor is positioned inside a housing, thereby preventing condensate water from leaking from the water storage container during a process of separating the water storage container to the outside.

According to an embodiment of the disclosure, a food waste disposer may include a pressing member capable of moving a water level sensor in a direction toward condensate water, thereby locating the water level sensor close to condensate water to be detected by the water level sensor.

According to an embodiment of the disclosure, a food waste disposer may include a case configured to accommodate a water level sensor therein such that, when the case is pressed, the water level sensor moves together with the case, thereby indirectly pressing the water level sensor toward condensate water to prevent damage of the water level sensor.

According to an embodiment of the disclosure, a food waste disposer may provide a sensor module that includes a first case including a first part case capable of accommodating a water level sensor therein and a second part case capable of being assembled with the first part case to prevent the water level sensor from being detached to the outside, the sensor module configured to easily accommodate the water level sensor in the first case.

Effects that may be achieved by the disclosure are not limited to the above-mentioned effects, and other effects not mentioned will be clearly understood by one of ordinary skill in the technical field to which the disclosure belongs from the following descriptions.

### DESCRIPTION OF DRAWINGS

FIG. 1 is a perspective view showing a food waste disposer according to an embodiment of the disclosure from front.

FIG. 2 is a perspective view showing the food waste disposer shown in FIG. 1 from front when a cover device opens according to an embodiment of the disclosure.

FIG. 3 is a perspective view showing the food waste disposer shown in FIG. 1 from behind according to an embodiment of the disclosure.

FIG. 4 is a cross-sectional view of the food waste disposer shown in FIG. 1 according to an embodiment of the disclosure.

FIG. 5 is an enlarged view of a part A of the food waste disposer of FIG. 4 according to an embodiment of the disclosure.

FIG. 6 is an exploded view showing some components of the food waste disposer shown in FIG. 1, from front according to an embodiment of the disclosure.

FIG. 7 is a perspective view showing some components of the food waste disposer shown in FIG. 1, from behind according to an embodiment of the disclosure.

FIG. 8 shows an air flow path during a sterilization operation of the food waste disposer shown in FIG. 1, from behind according to an embodiment of the disclosure.

FIG. 9 shows an air flow path during a food waste disposal operation of the food waste disposer shown in FIG. 8, from behind according to an embodiment of the disclosure.

FIG. 10 shows an air flow path of the food waste disposer shown in FIG. 9, from side according to an embodiment of the disclosure.

FIG. 11 is a perspective view showing a water storage device of the food waste disposer shown in FIG. 9 according to an embodiment of the disclosure.

FIG. 12 is a perspective view showing a state in which a water storage container is separated from the water storage device of the food waste disposer shown in FIG. 11 according to an embodiment of the disclosure.

FIG. 13 is a perspective view showing the water storage device of the food waste disposer shown in FIG. 11, from behind according to an embodiment of the disclosure.

FIG. 14 is an exploded view of the water storage device of the food waste disposer shown in FIG. 13 according to an embodiment of the disclosure.

FIG. 15 is a cross-sectional perspective view showing a cross section of the food waste disposer shown in FIG. 13 according to an embodiment of the disclosure.

FIG. 16 is a perspective view showing a sensor module of the food waste disposer shown in FIG. 13 according to an embodiment of the disclosure.

FIG. 17 is an exploded view of the sensor module of the food waste disposer shown in FIG. 16 according to an embodiment of the disclosure.

FIG. 18 is a cross-sectional perspective view showing a cross section of the sensor module of the food waste disposer shown in FIG. 16 according to an embodiment of the disclosure.

FIG. 19 is a perspective view showing a state in which the sensor module of the food waste disposer shown in FIG. 16 is installed in a water storage housing according to an embodiment of the disclosure.

FIG. 20 is a cross-sectional view showing a state in which a water storage container is separated from a water storage device of the food waste disposer shown in FIG. 11 according to an embodiment of the disclosure.

FIG. 21 is a cross-sectional view showing a state in which the water storage container is accommodated in the water storage device of the food waste disposer shown in FIG. 20 according to an embodiment of the disclosure.

FIG. 22 is an enlarged view of a sensor module in the water storage device of the food waste disposer shown in FIG. 21 according to an embodiment of the disclosure.

FIG. 23 is a cross-sectional view of the water storage device of the food waste disposer shown in FIG. 20, taken from another direction according to an embodiment of the disclosure.

FIG. 24 is an enlarged view of a sensor module in the water storage device of the food waste disposer shown in FIG. 23 according to an embodiment of the disclosure.

FIG. 25 is a control block diagram showing an operation of a water level sensor shown in FIG. 23 according to an embodiment of the disclosure.

FIG. 26 is an enlarged cross-sectional view of a sensor module of a food waste disposer according to an embodiment of the disclosure.

FIG. 27 is an enlarged cross-sectional view of a sensor module of a food waste disposer according to an embodiment of the disclosure.

FIG. 28 is an enlarged cross-sectional view of a sensor module of a food waste disposer according to an embodiment of the disclosure.

FIG. 29 is an exploded view showing a part of a first case and a second case of a food waste disposer according to an embodiment of the disclosure.

FIG. 30 is an exploded view showing a part of a first case and a second case of a food waste disposer according to an embodiment of the disclosure.

FIG. 31 is an exploded view showing a valve module of a food waste disposer according to an embodiment of the disclosure.

FIG. 32 is a cross-sectional view showing a state in which a water storage container in which the valve module of the food waste disposer shown in FIG. 31 is installed is located at an accommodation position according to an embodiment of the disclosure.

FIG. 33 is a cross-sectional view showing a state in which the water storage container in which the valve module of the food waste disposer shown in FIG. 31 is installed is located at a separation position according to an embodiment of the disclosure.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

The term “and/or” includes any and all combinations of one or more of associated listed components.

Terms such as “first”, “second”, or “1st” or “2nd” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that any of the above components can be connected to the other components directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

Meanwhile, in the following description, the terms “up-down direction”, “lower side”, “front-rear direction”, etc. are defined based on the drawings, and the shapes and positions of the components are not limited by the terms.

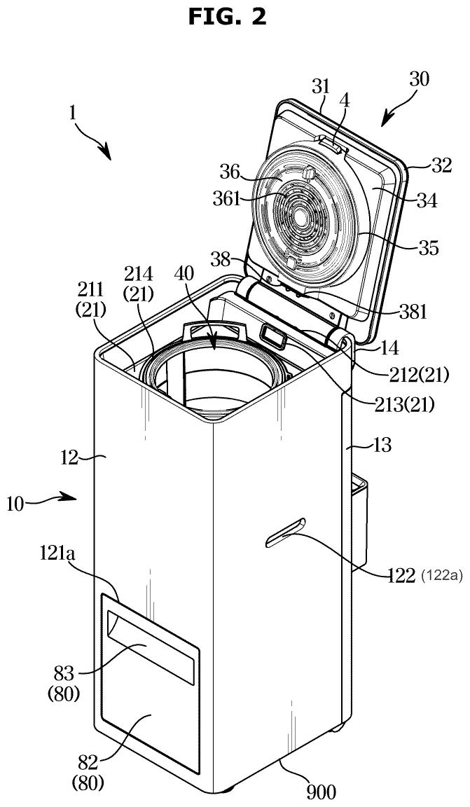

More specifically, as shown in FIG. 2, a direction in which a gripping portion of a food waste disposer 1 faces may be defined as a front direction, and a rear direction, left and right sides, and upper and lower sides may be defined based on the front direction.

Food which will be described below may refer to things that can be eaten by humans or animals. However, food may not be limited to things that can be eaten. Food may be organic. However, anything that contains moisture, even though the thing is inorganic, may be food.

Food waste may refer to food that has lost usefulness. For example, food waste may refer to leftover food after a meal or food that has been in packaging for a long time without being opened.

The food waste disposer 1 may mean a mechanism capable of processing food waste. For example, the food waste disposer 1 may mean a mechanism for grinding food waste to reduce a volume of the food waste or evaporating moisture from food to reduce a weight of food waste.

Hereinafter, an embodiment of the disclosure will be described in detail with reference to the accompanying drawings.

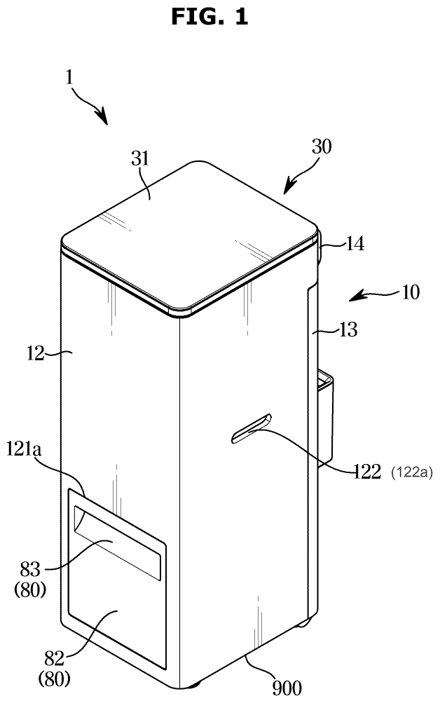

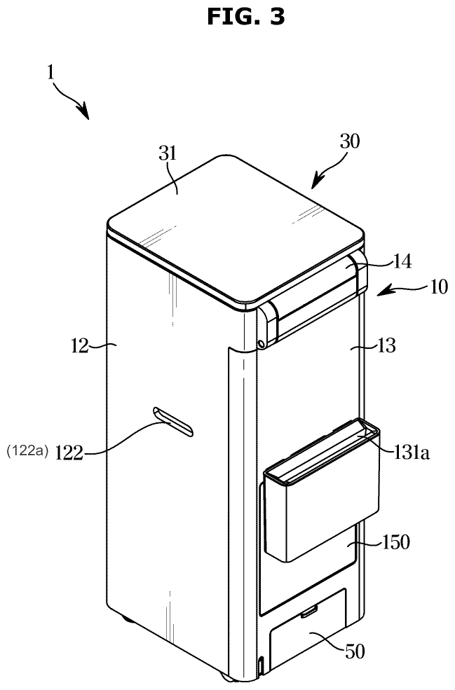

FIG. 1 is a perspective view showing a food waste disposer according to an embodiment of the disclosure from front. FIG. 2 is a perspective view showing the food waste disposer according to an embodiment of the disclosure from front when a cover device opens. FIG. 3 is a perspective view showing the food waste disposer according to an embodiment of the disclosure from behind.

Referring to FIGS. 1 to 3, the food waste disposer 1 may include a housing 10 and a cover device 30 that covers an upper side of the housing 10.

The housing 10 may form an appearance of the food waste disposer 1. For example, the housing 10 may include a base housing 900, and a first cover housing 12 and a second cover housing 13 mounted on the base housing 900.

The base housing 900 may form a bottom 412 of the food waste disposer 1, and the first cover housing 12 and the second cover housing 13 may form sides of the food waste disposer 1.

The base housing 900 may be detachably coupled to the first cover housing 12 and the second cover housing 13.

In FIGS. 1 to 3, the first cover housing 12 and the second cover housing 13 are shown to be formed separately, although not limited thereto. However, the first cover housing 12 and the second cover housing 13 may be integrated into one body.

A user or an installation engineer may easily access various components positioned inside the food waste disposer 1 by separating the first cover housing 12 and the second cover housing 13 from the base housing 900.

The first cover housing 12 of the food waste disposer 1 may include a storage device accommodating portion 121a and a gripping groove 122a.

The storage device accommodating portion 121a may be formed by opening a part of a front portion of the first cover housing 12. The storage device accommodating portion 121a may accommodate a storage case 81 of a storage device 80 which will be described below. The storage case 81 may be taken out of the storage device accommodating portion 121a in a front direction or inserted into the storage device accommodating portion 121a in a rear direction.

For example, the storage case 81 may slidingly move along a front-rear direction of the food waste disposer 1 to be taken out of the storage device accommodating portion 121a or inserted into the storage device accommodating portion 121a.

A gripping portion 83 that is gripped may be formed on an exposed portion 82 of the storage case 81.

The exposed portion 82 of the storage case 81 may form a front surface of the storage case 81. The exposed portion 82 of the storage case 81 may be exposed to outside of the food waste disposer 1 through the storage device accommodating portion 121a of the first cover housing 12.

The gripping portion 83 of the storage case 81 may have a shape that is depressed backward from a front surface of the exposed portion 82 of the storage case 81.

The exposed portion 82 of the storage case 81 may include a window, which is not shown. A user may check, with the naked eye, an amount of food waste collected in the storage case 81 through the window including a transparent material.

The gripping groove 122 of the first cover housing 12 may be formed by cutting out a part of the first cover housing 12. The user may grip the food waste disposer 1 through the gripping groove 122 and move a position of the food waste disposer 1.

The food waste disposer 1 may include a housing discharge portion 131a provided in a rear portion of the second cover housing 13.

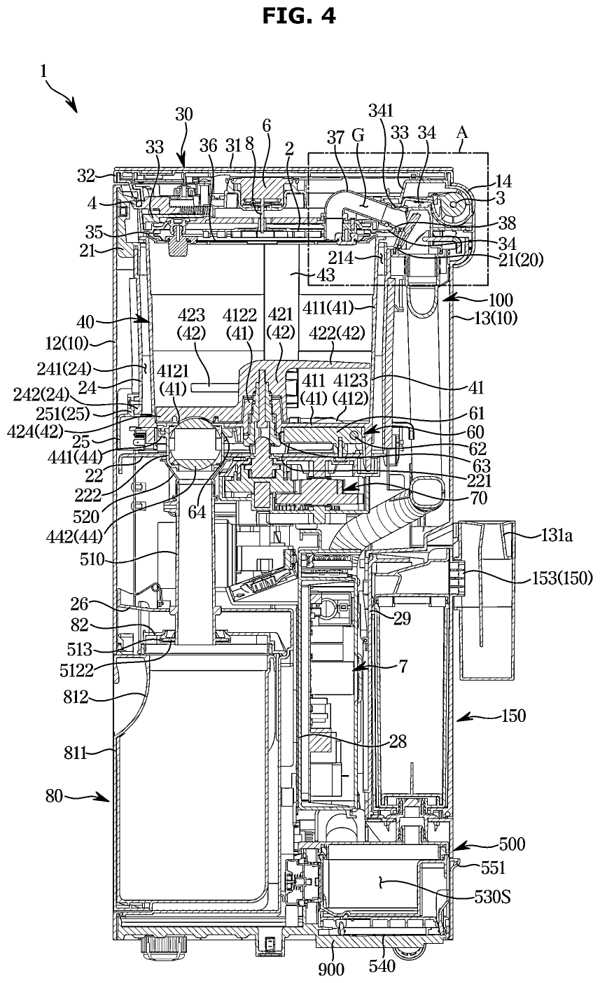

The housing discharge portion 131a may communicate with a filter discharge portion 153 (see FIG. 4) of a filter assembly 150. Accordingly, air filtered inside the filter assembly 150 may be discharged to the outside of the food waste disposer 1 through the filter discharge portion 153 and the housing discharge portion 131a.

A water storage container 530 may be positioned below the filter assembly 150. The water storage container 530 may be detachably mounted on the base housing 900. The water storage container 530 may collect condensate water generated in a deodorizing device 100. Details about this will be described below.

The food waste disposer 1 may include a hinge housing 14. The hinge housing 14 may connect the cover device 30 to the housing 10. For example, the hinge housing 14 may be connected to the cover device 30 and coupled to the second cover housing 13. Accordingly, through a configuration of the hinge housing 14, the cover device 30 may be rotatable with respect to the housing 10.

The cover device 30 may open or close the open upper side of the housing 10. The cover device 30 may be rotatably mounted on the housing 10 to cover the upper side of the housing 10.

For example, the cover device 30 may cover open upper sides of the first cover housing 12 and the second cover housing 13.

The cover device 30 may be mounted on the housing 10 to cover an upper side of a disposal device 40. The cover device 30 may transfer air in the disposal device 40 to the deodorizing device 100 in a state of closing the housing 10. Details about this will be described below.

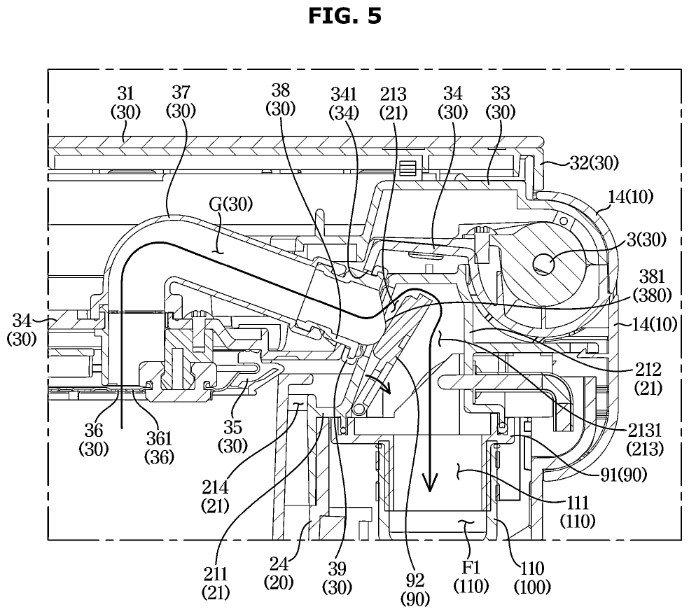

FIG. 4 is a cross-sectional view of the food waste disposer according to an embodiment of the disclosure. FIG. 5 is an enlarged view of a part A of FIG. 4.

Hereinafter, an overall configuration of the food waste disposer 1 according to an embodiment of the disclosure will be described with reference to FIGS. 1 to 5.

Referring to FIGS. 4 and 5, the food waste disposer 1 may include the cover device 30 mounted on an outer side of the housing 10 to open or close an upper side of the disposal device 40, and the disposal device 40 accommodated inside the housing 10.

The cover device 30 may include a top plate 31, an upper frame 32, a middle frame 33, and a lower frame 34.

The top plate 31 may form an upper surface of the food waste disposer 1. For example, while the cover device 30 closes the upper side of the housing 10, the top plate 31 may be provided as an upper surface of the food waste disposer 1. The top plate 31 may form an upper appearance of the food waste disposer 1.

The upper frame 32, the middle frame 33, and the lower frame 34 may be positioned below the top plate 31. The upper frame 32 may be coupled to the middle frame 33. The middle frame 33 may be coupled to the lower frame 34. The middle frame 33 may be positioned between the upper frame 32 and the lower frame 34.

A preset accommodating space may be formed between the upper frame 32 and the middle frame 33. A preset accommodating space may be formed between the middle frame 33 and the lower frame 34.

For example, the upper frame 32 may be coupled to the middle frame 33 to form a space with a preset distance in a vertical direction. Also, the middle frame 33 may be coupled to the lower frame 34 to form a space with a preset distance in the vertical direction.

The cover device 30 may include a cover frame 36 and a cover gasket 35.

The cover frame 36 may form a lower surface of the cover device 30. The cover frame 36 may have a size that is accommodated in a food waste inlet above the disposal device 40. The cover frame 36 may include an inlet hole 361 (see FIG. 2) through which air flows from the disposal device 40. Inside air of the disposal device 40 may flow to the guide duct 37 which will be described below, through the inlet hole 361 of the cover frame 36.

The cover frame 36 may be provided in a shape corresponding to an inlet of the disposal device 40. Referring to FIG. 2, the inlet of the disposal device 40 may have a circular shape, and accordingly, the cover frame 36 may also have a circular shape. However, the shapes of the cover frame 36 and the inlet of the disposal device 40 are not limited thereto.

The cover gasket 35 may cover an outer edge of the cover frame 36.

The cover gasket 35 may seal between the cover frame 36 and the inlet of the disposal device 40. The cover gasket 35 may be in contact with an upper edge of the disposal device 40.

For example, the cover gasket 35 may prevent, while the cover device 30 closes the upper side of the housing 10, air in the disposal device 40 from leaking out of the cover device 30. Accordingly, the cover gasket 35 may prevent air containing contaminants inside the disposal device 40 from leaking out of the food waste disposer 1 without passing through the deodorizing device 100.

The cover gasket 35 may be made of a material having preset elasticity.

The cover device 30 may be rotatable on a cover device rotating shaft 3 with respect to the housing 10. For example, the cover device rotating shaft 3 may be coupled to the hinge housing 14 to enable the cover device 30 to rotate to open or close the upper side of the housing 10.

However, the operation of the cover device 30 is not limited thereto, and the cover device 30 may open or close the upper side of the housing 10 by sliding or being completely separated from the housing 10 without the hinge housing 14.

The cover device 30 may include a locking member 4.

The locking member 4 may be installed in the middle frame 33. The locking member 4 may be elastically movable along the front-rear direction of the food waste disposer 1.

The locking member 4 may be inserted in an accommodating frame 21 which will be described below. Accordingly, while the cover device 30 closes the upper side of the housing 10, the locking member 4 may maintain the closed state of the cover device 30.

However, the shape of the locking member 4 is not limited thereto, and the locking member 4 may be provided in a hook shape to temporarily fix a position of the cover device 30.

The cover device 30 may include a circulation fan 2, a fan rotating shaft 8, and a fan driver 6.

The circulation fan 2 may be positioned between the middle frame 33 and the lower frame 34. The fan driver 6 may be positioned between the upper frame 32 and the middle frame 33.

The fan rotating shaft 8 may connect the fan driver 5 to the circulation fan 2 to transfer power of the fan driver 6 to the circulation fan 2. The fan rotating shaft 8 may penetrate the middle frame 33 and be coupled to the circulation fan 2.

The circulation fan 2 may be provided above the disposal device 40 to evenly distribute heat inside a grinding case 41 of the disposal device 40.

For example, while a heating device 60 provided below the disposal device 40 heats the disposal device 40, food waste inside the disposal device 40 may be heated.

At this time, the food waste inside the disposal device 40 may be more heated at a part being adjacent to the heating device 60. Accordingly, heat may be unevenly transferred to the food waste accommodated in the disposal device 40.

Accordingly, by positioning the circulation fan 2 in the cover device 30, heat inside the disposal device 40 may evenly circulate. In other words, the circulation fan 2 may cause a convection phenomenon inside the grinding case 41.

Accordingly, internal temperature of the grinding case 41 may become nearly uniform regardless of location, and drying efficiency of food waste accommodated in the grinding case 41 may be improved.

The cover device 30 may include a guide duct 37.

The guide duct 37 may penetrate the lower frame 34. While the cover device 30 rotates, the guide duct 37 may rotate together with the cover device 30.

For example, while the cover device 30 closes the upper side of the housing 10, one end of the guide duct 37 may face inside of the grinding case 41 together with the cover frame 36.

For example, while the cover device 30 closes the upper side of the housing 10, one end of the guide duct 37b may face downward.

The guide duct 37 may be installed inside the cover device 30. One end of the guide duct 37 may be fixed to the lower frame 34. One end of the guide duct 37 may open toward the cover frame 36. Another end of the guide duct 37 may be coupled to a connecting duct 38 which will be described below.

The guide duct 37 may extend in a curved shape. However, the shape of the guide duct 37 is not limited thereto. For example, the shape of the guide duct 37 is not limited as long as the guide duct 37 is capable of guiding air inside the grinding case 41 to an exhaust pipe.

The guide duct 37 may form a guide path G to which air of the disposal device 40 flows. The guide path G may communicate with the disposal device 40. More specifically, because one end of the guide duct 37 opens toward the cover frame 36, air of the disposal device 40 may flow to the guide duct 37 through the inlet hole 361 of the cover frame 36.

The cover device 30 may include a connecting duct 38 and a duct sealing member 39.

The connecting duct 38 may be coupled to the other end of the guide duct 37. For example, the connecting duct 38 may be coupled to a rear end of the guide duct 37. The connecting duct 38 may be coupled to a duct installing portion 341 of the lower frame 34.

The connecting duct 38 may connect the guide duct 37 accommodated in the cover device 30 to an exhaust portion 213 formed in the accommodating frame 21. One end of the connecting duct 38 may be connected to the guide duct 37, and another end of the connecting duct 38 may protrude outward from the cover device 30 through the duct installing portion 341.

The connecting duct 38 may include a pusher 381. The pusher 381 may protrude outward behind the cover device 30.

The pusher 381 may press a blocking member 92 that maintains a closed state of the exhaust portion 213 of the accommodating frame 21 which will be described below. Details about this will be described below.

The duct sealing member 39 may be coupled to the other end of the connecting duct 38. For example, the duct sealing member 39 may be coupled to one portion of the connecting duct 38 protruding outward from the cover device 30 through the duct installing portion 341.

The duct sealing member 39 may seal between the connecting duct 38 of the cover device 30 and the exhaust portion 213 of the accommodating frame 21. While the cover device 30 closes the upper side of the housing 10, the duct sealing member 39 may prevent air flowing to the connecting duct 38 through the guide duct 37 from leaking into a gap between the connecting duct 38 and the exhaust portion 213. Accordingly, air containing contaminants may be prevented from leaking out without passing through the deodorizing device.

The disposal device 40 may be positioned below the cover device 30 and opened or closed by the cover device 30.

The disposal device 40 may include the grinding case 41 for disposal of food waste. Disposal of food waste may be used as term referring to a task of drying, stirring, and grinding food waste. Also, disposal of food waste may be used as term referring to any task of drying, stirring, or grinding food waste.

The disposal device 40 may accommodate food waste. The disposal device 40 may be positioned inside the housing 10 and detachable to the outside of the housing 10. The disposal device 40 may include a handle 413. A user may grip the handle 413 and separate the disposal device 40 inside the housing 10 to the outside of the housing 10.

An upper side of the grinding case 41 may open to form an inlet. A user may put food waste into the disposal device 40 through the inlet of the grinding case 41.

The inlet of the grinding case 41 may be closed by the cover frame 36 of the cover device 30. The cover gasket 35 of the cover device 30 may seal a gap between the inlet of the grinding case 41 and the cover frame 36.

The grinding case 41 may include a side wall 411 and a bottom 412.

On the side wall 411 of the grinding case 41, a fixed grinder 43 may be installed. A rotating grinder 42 may be positioned on the bottom 412 of the grinding case 41 and connected to a first driver 72 so as to be rotatable.

The rotating grinder 42 and the fixed grinder 43 may grind food waste through interaction.

The rotating grinder 42 may include a rotating body 421 to which a grinder shaft 71 of the first driver 72 is coupled. The rotating grinder 42 may include a first grinder 422, a second grinder 423, and a third grinder 424, which extend radially from the rotating body 421. The first grinder 422, the second grinder 423, and the third grinder 424 may be positioned at different heights to stir and grind food waste.

In FIG. 4, the rotating grinder 42 is shown to include the first grinder 422 to the third grinder 424. However, the number of grinders is not limited thereto.

On the bottom 412 of the grinding case 41, a transfer portion 4121 may be formed. The transfer portion 4121 may be formed by cutting out a part of the bottom 412 of the grinding case 41. Food waste processed in the grinding case 41 may be transferred to the storage device 80 through the transfer portion 4121.

A rotating shaft accommodating portion 4122 may be formed on the bottom 412 of the grinding case 41. The rotating shaft accommodating portion 4122 may extend upward from a center of the grinding case 41. The grinder shaft 71 of the first driver 72 may be inserted in the rotating shaft accommodating portion 4122 to transfer power to the rotating body 421 of the rotating grinder 42.

The disposal device 40 may include a valve assembly 44.

The valve assembly 44 may include a valve case 441 and a ball valve 442.

The valve case 441 may be coupled to a lower portion of the grinding case 41. The valve case 441 may be coupled to the grinding case 41 at a location of communicating with the transfer portion 4121 of the grinding case 41.

The valve case 441 may accommodate the ball valve 442 therein. More specifically, the valve case 441 may cover an outer side of the ball valve 442 such that the ball valve 442 is rotatable inside the valve case 42.

The ball valve 442 may be rotatable inside the valve case 441. The ball valve 442 may rotate to open or close the transfer portion 4121 of the grinding case 41.

The ball valve 442 may pass through the transfer portion 4121 of the grinding case 41 and protrude upward from the bottom 412 of the grinding case 41. Accordingly, a lower surface of the third grinder 424 of the rotating grinder 42 may be depressed inward to correspond to a protruding shape of the ball valve 442. Accordingly, the third grinder 424 may be prevented from interfering with the ball valve 442.

Also, due to the shape of the third grinder 424, a protrusion 4123 may be formed in the bottom 412 of the grinding case 41.

The protrusion 4123 may protrude upward from the bottom 412.

By forming the protrusion 4123 corresponding to the depressed shape of the third grinder 424 in the bottom 412 of the grinding case 41, the third grinder 424 may transfer food waste collected on the bottom 412 of the grinding case 41 to the transfer portion 4121 without leaving any food waste and efficiently stir food waste.

The ball valve 442 may be provided in a ball shape of which an inner part partially opens.

The ball valve 442 of the valve assembly 44 may rotate by receiving a driving force of the driver 70. For example, the ball valve 442 may rotate by receiving a driving force from a second driver 73 to open or close the transfer portion 4121 of the grinding case 41.

Also, while the ball valve 442 rotates to open the transfer portion 4121, the second driver 73 may interfere with an upward movement of the ball valve 442 to prevent the ball valve 442 from being separated from the second driver 73.

Therefore, it may be possible to prevent food waste from leaking out when a user separates the disposal device 40 without recognizing that the transfer portion 4121 is open.

The food waste disposer 1 may include the heating device 60.

The heating device 60 may include a heating frame 61 and a heating wire accommodated in the heating frame 61.

The heating frame 61 may be in contact with the lower portion of the disposal device 40. The bottom 412 of the disposal device 40 may be heated by the heating wire 62 accommodated inside the heating frame 61.

The food waste disposer 1 may include the driver 70.

The driver 70 may be positioned below the heating device 60.

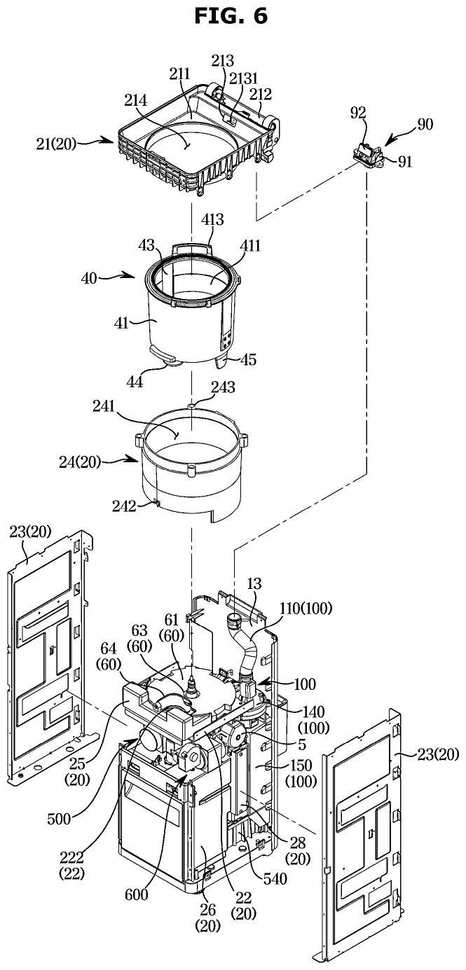

The driver 70 may include the first driver 72 (see FIG. 6) and the second driver 73 (see FIG. 6). The first driver 72 may transfer a driving force to the rotating grinder 42 of the disposal device 40, and the second driver 73 may transfer a driving force to the valve assembly 44 of the disposal device 40.

The food waste disposer 1 may include the storage device 80.

The storage device 80 may be positioned inside a storage frame. The storage device 80 may be connected to a transfer duct 27. An upper end of the transfer duct 27 may be connected to the valve assembly 44, and a lower end of the transfer duct 27 may be connected to the storage device 80.

While the valve assembly 44 opens the transfer portion 4121, food waste processed in the disposal device 40 may be transferred to the transfer duct 27. The food waste transferred to the transfer duct 27 may be stored in the storage device 80.

The storage device 80 may be positioned below a front portion of the disposal device 40 to store food waste processed in the disposal device 40.

The storage device 80 may include the storage case 81 and the exposed portion 82 coupled to the storage case 81 and exposed to the outside of the food waste disposer 1. The gripping portion 83 may be formed in an upper end of the exposed portion 82. Accordingly, a user may grip the gripping portion 83, separate the storage device 80 from the housing 10, and empty food waste collected in the storage device 80 from the storage device 80.

The food waste disposer 1 may include a machine room 7. Electric components such as various circuit boards may be positioned in the machine room 7.

The food waste disposer 1 may include a controller. The controller may control various components of the food waste disposer 1. Accordingly, the controller may control an operation of the food waste disposer 1 based on an electronic signal generated in the machine room 7.

The food waste disposer 1 may include an exhaust opening/closing device 90.

The exhaust opening/closing device 90 may include a frame coupling body 91 and the blocking member 92. The blocking member 92 may open or close the exhaust portion 213 of the accommodating frame 21. While the cover device 30 opens the upper side of the housing 10, the blocking member 92 may be at a position of closing the exhaust portion 213.

The frame coupling body 91 may be connected to an end of a first exhaust pipe 110 which will be described below. The frame coupling body 91 may be coupled to a lower portion of the accommodating frame 21.

The frame coupling body 91 may connect the accommodating frame 21 to the first exhaust pipe 110. The frame coupling body 91 may form a communication space 2131 therein. The communication space 2131 may communicate with the guide path G of the guide duct 37. The communication space 2131 may communicate with a first exhaust path F1 of the first exhaust pipe 110.

The blocking member 92 may be elastically supported on the frame coupling body 91. The blocking member 92 may be coupled to the frame coupling body 91 and maintain a state of closing the exhaust portion 213 of the accommodating frame 21. The blocking member 92 may be movable inside the communication space 2131.

The food waste disposer 1 may include the deodorizing device 100.

The deodorizing device 100 may be connected to the cover device 30. The deodorizing device 100 may include the first exhaust pipe 110 connected to the cover device 30.

The first exhaust pipe 110 may include a first inlet 111 connected to the communication space 2131 of the frame coupling body 91. The first exhaust pipe 110 may form the first exhaust path F1 through which air of the disposal device 40 flows.

The deodorizing device 100 may be positioned in a rear portion of the food waste disposer 1. Details about the deodorizing device 100 will be described below.

The food waste disposer 1 may include the water storage container 530.

The water storage container 530 may be positioned on the base housing 900 to collect condensate water generated in an exhaust path of the deodorizing device 100.

For example, the water storage container 530 may be installed in a water storage housing 540 of the base housing 900. The water storage container 530 may form a condensate water collecting space 521 therein. The water storage container 530 may be positioned below the filter assembly 150 and connected to the filter assembly 150. Details about the water storage container 530 will be described below.

A flow of air when the cover device 30 closes the upper side of the housing 10 will be described with reference to FIG. 5.

As shown in FIG. 5, while the cover device 30 closes the upper side of the housing 10, the pusher 381 formed in the connecting duct 38 may press the blocking member 92 positioned inside the accommodating frame 21.

For example, the pusher 381 may pass through the exhaust portion 213 of the accommodating frame 21 and press the blocking member 92. While the blocking member 92 is pressed and thus rotates toward the communication space 2131, the blocking member 92 may open the exhaust portion 213 of the accommodating frame 21.

While the blocking member 92 opens the exhaust portion 213 of the accommodating frame 21, inside of the connecting duct 38 may be connected to the communication space 2131 such that air flows.

Also, because the communication space 2131 communicates with the first inlet 111 of the first exhaust pipe 110, the pusher 281 may press the blocking member 92 to open the first inlet 111 of the first exhaust pipe 110.

That is, while the cover device 30 closes the upper side of the housing 10, the blocking member 92 may elastically move to a position of opening the exhaust portion 213.

Accordingly, inside air of the disposal device 40 may flow into the cover device 30 through the inlet hole 361 of the cover frame 36 of the cover device 30. Air passed through the inlet hole 361 may flow into the guide duct 37 of the cover device 30. In other words, air of the disposal device 40 may flow along the guide path G.

Then, the air passed through the guide duct 37 and the connecting duct 38 may flow to the communication space 2131 through the open exhaust portion 213 of the accommodating frame 21.

The air flowed to the communication space 2131 may flow along the first exhaust path F1 through the first inlet 111 of the first exhaust pipe 110. This flow of air may be formed by an exhaust fan 140 which will be described below.

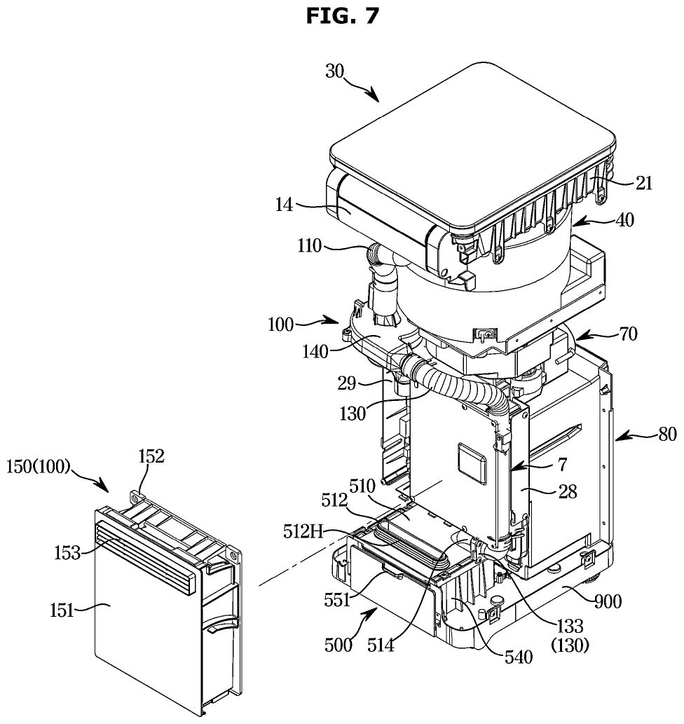

FIG. 6 is an exploded view showing some components of the food waste disposer according to an embodiment of the disclosure, from front. FIG. 7 is an exploded perspective view showing some components of the food waste disposer according to an embodiment of the disclosure, from behind.

The food waste disposer 1 may include a plurality of internal frames 20. In FIG. 6, for convenience of description, the cover device 30 and the first cover housing 12 are omitted.

Hereinafter, a detailed structure of the internal frames 20 of the food waste disposer 1 and an arrangement of various devices will be described.

Referring to FIGS. 6 and 7, the food waste disposer 1 may include the accommodating frame 21.

The accommodating frame 21 may include a base portion 211, a hinge installing portion 212, the exhaust portion 213, and an opening 214.

The accommodating frame 21 may be positioned between the housing 10 and the disposal device 40 to cover an outer side of the disposal device 40. For example, the base portion 211 of the accommodating frame 21 may be positioned between the housing 10 and the disposal device 40 to cover the outer side of the disposal device 40.

The hinge installing portion 212 may be formed in a rear side of the base portion 211. The hinge housing 14 may be coupled to the hinge installing portion 212 of the accommodating frame 21. The cover device 30 may be rotatably coupled to the hinge installing portion 212 of the accommodating frame 21.

The exhaust portion 213 may be formed in the rear side of the base portion 211. The exhaust portion 213 may connect the guide path G of the cover device 30 to the exhaust path of the deodorizing device 100.

The exhaust portion 213 may communicate with the guide path G and the exhaust path. The exhaust portion 213 may be formed by cutting out a part of an inner side of the base portion 211.

The accommodating frame 21 may include the communication space 2131 connected to the exhaust portion 213. The communication space 2131 may be formed in the rear portion of the accommodating frame 21. The exhaust opening/closing device 90 may be accommodated in the communication space 2131.

The opening 214 may be formed by opening an inner side of the base portion 211. The disposal device 40 may be separated outward from the accommodating frame 21 through the opening 214. The opening 214 may communicate with the inlet of the disposal device 40.

The food waste disposer 1 may include a support frame 22, a case frame 24, and a fixing frame 25.

The support frame 22 may be positioned below the heating device 60 and support the heating device 60 and the disposal device 40. In a front portion of the support frame 22, the fixing frame 25 may be positioned. The fixing frame 25 may include a frame fixing portion 251 coupled to the case frame 24.

The case frame 24 may accommodate the disposal device 40. The case frame 24 may have a shape corresponding to the disposal device 40. For example, the case frame 24 may have a substantially cylindrical shape of which upper and lower sides open.

The case frame 24 may include a disposal device accommodating space 241. The disposal device 40 may be positioned inside the disposal device accommodating space 241 in such a way at to be spaced a preset distance from the case frame 24.

The case frame 24 may include a case fixing portion 242. The case fixing portion 242 may be coupled to a frame fixing portion 251 of the fixing frame 25. Accordingly, the case frame 24 may be fixed with respect to the fixing frame 25.

The case frame 24 may include a frame coupling portion 243. The case frame 24 may be coupled to a lower portion of the accommodating frame 21 by the frame coupling portion 243. Accordingly, the case frame 24 may be fixed with respect to the accommodating frame 21.

The food waste disposer 1 may include a side frame 23. A pair of side frames 23 may be provided.

The pair of side frames 23 may face each other. The side frames 23 may be coupled to both side surfaces of the accommodating frame 21. The side frames 23 may be coupled to the second cover housing 13.

The side frames 23 may be positioned in left and right sides of the food waste disposer 1 to cover the disposal device 40, the heating device 60, the driver 70, the storage device 80, and the deodorizing device 100.

Referring to FIGS. 4 and 6, the deodorizing device 100 may include the storage frame. The storage frame may include a first storage frame 261 and a second storage frame 262. However, the first storage frame 261 and the second storage frame 262 may be integrated into one body.

The storage frame may form a space where the storage device 80 is accommodated. The storage frame may be connected to the transfer duct 27.

The storage frame may prevent, when food waste is transferred through the transfer duct 27 while the storage device 80 is not accommodated inside the housing 10 or when food waste leaks out of the storage device 80 while a user takes the storage device 80 out, the food waste from influencing other internal components of the food waste disposer 1.

The food waste disposer 1 may include a first partition plate 28 positioned behind the storage device 80 to partition the machine room 7.

The driver 70 of the food waste disposer 1 may include the first driver 72 and the second driver 73.

The first driver 72 may include the grinder shaft 71 that penetrates a center of the heating device 60 and extends upward, and provide power to the rotating grinder 42.

The second driver 73 may provide power to the valve assembly 44. The first driver 72 and the second driver 73 may be controlled by the controller.

The heating device 60 may include a first shaft penetrating portion 63 and a second valve penetrating portion 64. The support frame 22 may include a second shaft penetrating portion 221 and a second valve penetrating portion 222.

The first shaft penetrating portion 63 and the second shaft penetration porting 221 may be formed in parallel in the vertical direction. The first valve penetrating portion 64 and the second valve penetrating portion 222 may be formed in parallel in the vertical direction.

The grinder shaft 71 of the first driver 72 may penetrate the first shaft penetrating portion 63 and the second shaft penetrating portion 221. Accordingly, the first driver 72 may penetrate the support frame 22 and the heating device 60 and transfer a driving force to the disposal device 40.

Because the valve assembly 44 of the disposal device 40 protrudes downward from the grinding case 41, the valve assembly 44 may protrude downward from the heating device 60 and the support frame 22 through the first valve penetrating portion 64 and the second valve penetrating portion 222.

The valve assembly 44 protruding downward from the heating device 60 and the support frame 22 may be driven by the second driver 73.

The ball assembly 442 of the valve assembly 44 may rotate by the second driver 73 to open or close the transfer portion 4121 of the grinding case 41.

The food waste disposer 1 may include a cooling fan 5.

The cooling fan 5 may be positioned below the heating device 60. The cooling fan 5 may circulate internal air of the housing 10 to discharge heat inside the housing 10 to the outside. The cooling fan 5 may be positioned to one side of the driver 70. The cooling fan 5 may be positioned in front of the exhaust fan 140.

The deodorizing device 100 may be positioned behind the disposal device 40. The deodorizing device 100 may be positioned on an inner side of the second cover housing 13.

Referring to FIGS. 6 and 7, the deodorizing device 100 may include the first exhaust pipe 110, the exhaust fan 140, a second exhaust pipe 130, and the filter assembly 150.

The exhaust fan 140 may be positioned inside the housing 10 to form a flow of air. The exhaust fan 140 may be positioned in a rear area of the housing 10. The exhaust fan 140 may intake air from the disposal device 40. The first exhaust pipe 110 and the second exhaust pipe 130 may be connected to the exhaust fan 140.

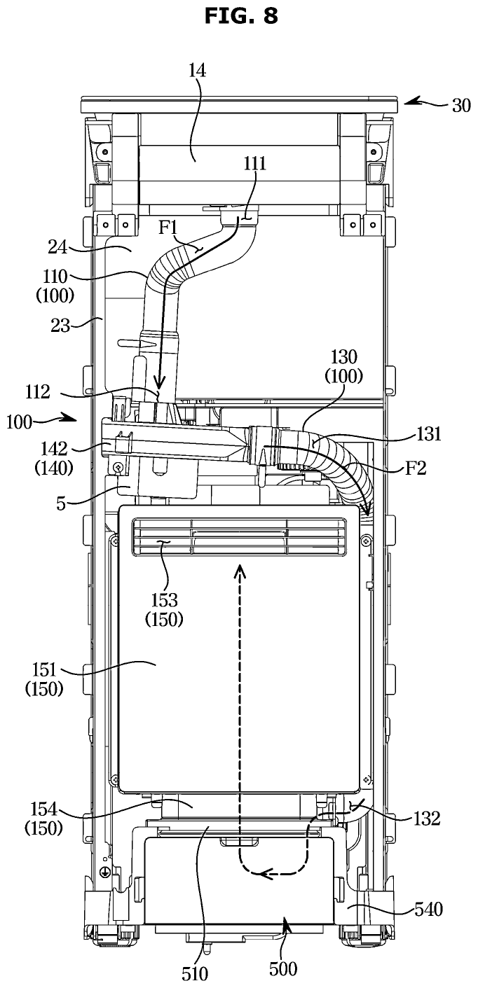

The first exhaust pipe 110 may be connected to the exhaust fan 140 at an upstream side of the exhaust fan 140, and the second exhaust pipe 130 may be connected to the exhaust fan 140 at a downstream side of the exhaust fan 140. The first exhaust pipe 110 may be connected to the exhaust fan 140 to form the first exhaust path F1 (see FIG. 8) that communicates with the guide path G.

The first exhaust pipe 110 may form the first exhaust path F1 (see FIG. 8). The second exhaust pipe 130 may form a second exhaust path F2 (see FIG. 8). The first exhaust path F1 and the second exhaust path F2 may be collectively referred to as exhaust paths.

Air received from the disposal device 40 by the exhaust fan 140 may flow along the first exhaust pipe 110 and the second exhaust pipe 130.

The filter assembly 150 may adsorb contaminants from air flowing along the first exhaust pipe 110 and the second exhaust pipe 130. A filter for filtering out contaminants in air may be provided inside the filter assembly 150.

The filter assembly 150 may be connected to the exhaust paths through the exhaust pipes to adsorb contaminants from air flowing along the first exhaust path F1 and the second exhaust path F2.

Air flowed into the first exhaust pipe 110 and the second exhaust pipe 130 from the disposal device 40 may flow along the exhaust paths. The filter assembly 150 may be connected to the exhaust paths. More specifically, the filter assembly 150 may be connected to the exhaust paths through the first exhaust pipe 110 and the second exhaust pipe 130.

The storage container 530 may be connected to the filter assembly 150 and the second exhaust pipe 130. Accordingly, air flowing inside the second exhaust pipe 130 may pass through the storage container 530 and flow into the filter assembly 150.

The storage container 530 may be installed in the water storage housing 540 of the base housing 900. The storage container 530 may include a water storage cover 510.

The water storage cover 510 may form an upper surface of the water storage container 530. The water storage cover 510 may include an exhaust pipe connection portion 514 connected to the second exhaust pipe 130. For example, the exhaust pipe connection portion 514 of the water storage cover 510 may be coupled to a coupling flange 133 of the second exhaust pipe 130.

The water storage cover 510 may include a filter installing portion 512. The filter installing portion 512 may extend upward from the water storage cover 510 and be connected to a lower portion of the filter assembly 150. The filter installing portion 512 may form a path along which air flowed into the water storage container 530 through the second exhaust pipe 130 flows into the filter assembly 150.

The water storage container 530 may include a filter sealing member 513 coupled to the filter installing portion 512. The filter sealing member 513 may seal a gap between the water storage container 530 and the filter assembly 150.

The water storage container 530 may include a container gripping portion 533. The container gripping portion 533 may be exposed to outside of the second cover housing 13 of the food waste disposer 1. A user may grip the container gripping portion 533, separate the water storage container 530 from the housing 10, and remove collected condensate water.

The filter assembly 150 may include a filter case 151 in which a filter is accommodated. The filter case 151 may be coupled to a filter installing plate 152. The filter installing plate 152 may be coupled to a second partition plate 29 that partitions the machine room 7 from behind.

The filter discharge portion 153 may be formed in a rear side of the filter case 151. Air passed through the first exhaust pipe 110 and the second exhaust pipe 130 may pass through the water storage container 530 and flow into the filter assembly 150. Then, contaminants may be removed from the air by the filter assembly 150 and the air may be discharged to the outside of the food waste disposer 1 through the filter discharge portion 153.

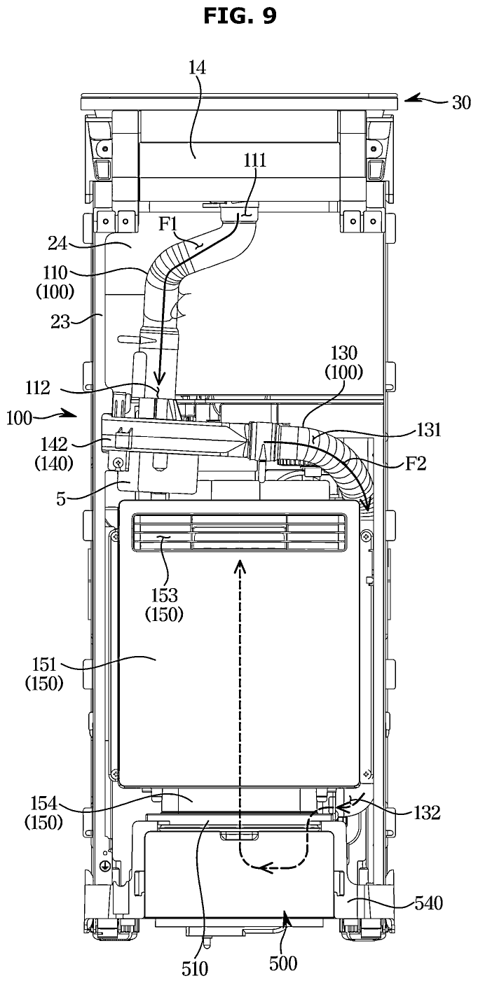

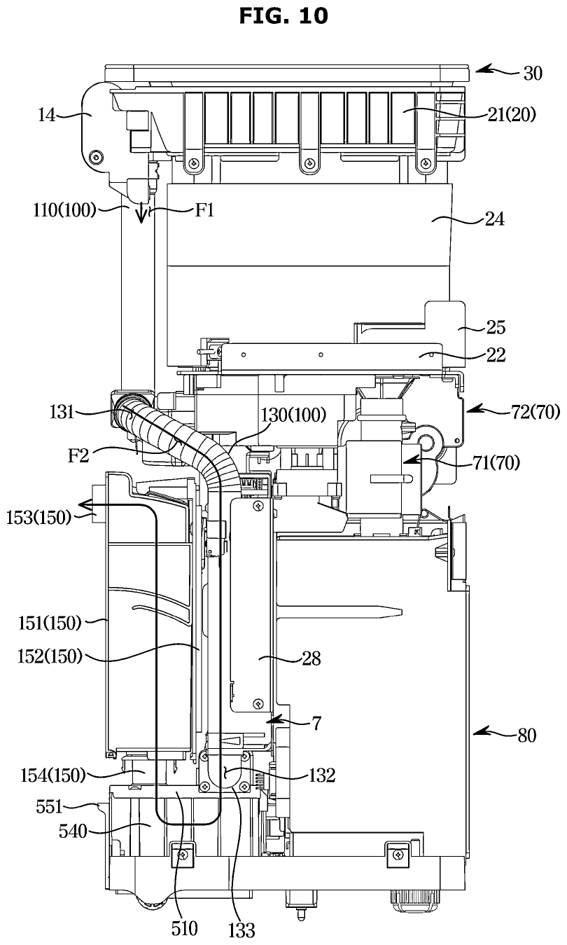

FIG. 8 shows an air flow path during a sterilization operation of the food waste disposer according to an embodiment of the disclosure, from behind. FIG. 9 shows an air flow path during a food waste disposal operation of the food waste disposer according to an embodiment of the disclosure, from behind. FIG. 10 shows an air flow path of the food waste disposer according to an embodiment of the disclosure, from side.

Overall air flows in a case where a sterilization process is performed and in a case where a food waste disposal process is performed, according to the disclosure, will be described with reference to FIGS. 8 to 10.

The first exhaust pipe 110 may include a first inlet 111 and a first outlet 112. The first inlet 111 may communicate with the guide path G and the communication space 2131 while the cover device 30 closes the upper side of the housing 10, ad described above. Air inside the disposal device 40 may flow into the first exhaust pipe 110 through the first inlet 111.

The first outlet 112 may communicate with an exhaust fan case 142. The first outlet 112 may allow air flowed into the first exhaust pipe 110 through the first inlet 111 to be discharged to the exhaust fan 140. The first exhaust path F1 may be formed between the first inlet 111 and the first outlet 112.

The first exhaust path F1 may communicate with the guide path G while the cover device 30 is closed with respect to the housing 10.

The second exhaust pipe 130 may form the second exhaust path F2.

The second exhaust pipe 130 may be connected to the exhaust fan 140 to form a downstream part of an exhaust path formed by the exhaust fan 140

The second exhaust pipe 130 may include a second inlet 131 and a second outlet 132. The second inlet 131 may communicate with the exhaust fan case 142. The second inlet 131 may allow air flowed through the first exhaust path F1 to flow into the second exhaust pipe 130.

The second outlet 132 may communicate with the water storage container 530. The second outlet 132 may allow air flowed into the second exhaust pipe 130 through the second inlet 131 to be discharged to the water storage container 530. The second exhaust path F2 may be formed between the second inlet 131 and the second outlet 132.

The second exhaust pipe 130 may include a coupling flange 133 coupled to the water storage cover 510 of the water storage container 530.

The water storage container 530 may be positioned between the second exhaust pipe 130 and the filter assembly 150. The water storage container 530 may collect condensate water generated from air flowed through the first exhaust path F1 and the second exhaust path F2. The water storage cover 510 of the water storage container 530 may be connected to the second exhaust pipe 130 and the filter assembly 150.

During a food waste disposal operation, air inside the disposal device 40 may flow into the first exhaust pipe 110 through the first inlet 111, flow along the first exhaust path F1, and flow into the exhaust fan 140 through the first outlet 112.

Then, the air may flow into the second exhaust pipe 130 through the second inlet 131, flow along the second exhaust path F2, and flow into the water storage container 530 through the second outlet 132. Air flowed into the water storage container 530 may flow into the filter assembly 150 through the filter connecting portion 154, contaminants may be removed from the air, and then the air may be discharged to the outside through the filter discharge portion 153.

A flow of air may be formed even while a food waste disposal operation is not performed. For example, the exhaust fan 140 may operate even while operations of grinding, stirring, and drying food waste are not performed in the disposal device 40.

Accordingly, a function of filtering and discharging foul odors that may be generated in any situation inside the food waste disposer may be performed.

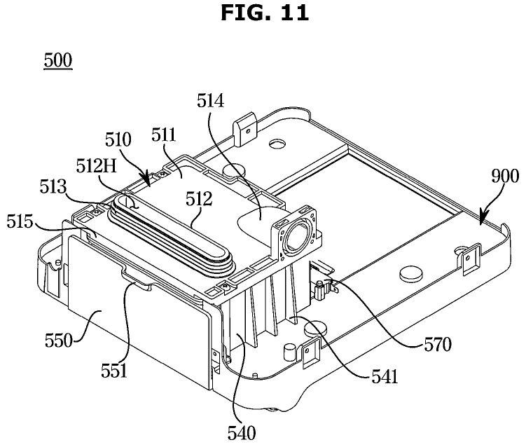

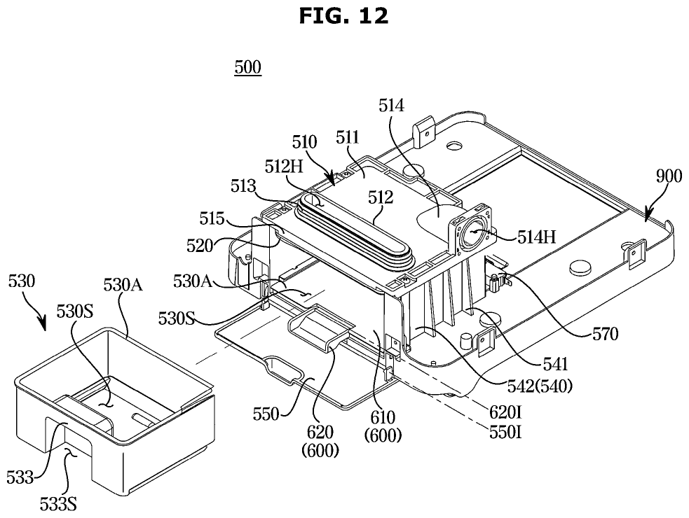

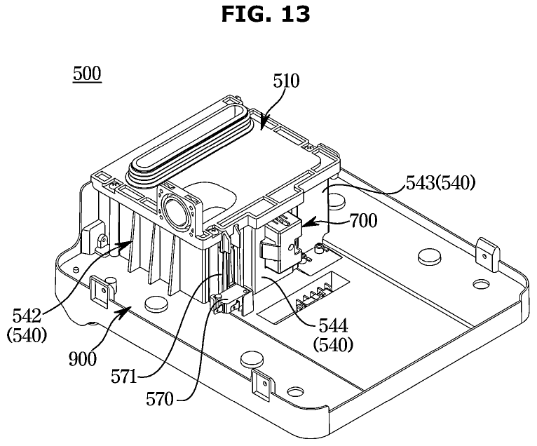

FIG. 11 is a perspective view showing the water storage device 500 of the food waste disposer 1 shown in FIG. 9. FIG. 12 is a perspective view showing a state in which the water storage container 530 is separated from the water storage device 500 of the food waste disposer 1 shown in FIG. 11. FIG. 13 is a perspective view showing the water storage device 500 of the food waste disposer 1 shown in FIG. 11, from behind.

The water storage device 500 according to an embodiment of the disclosure will be described with reference to FIGS. 11 to 13.

The food waste disposer 1 may include the water storage device 500. The water storage device 500 may be connected to the exhaust pipes 110 and 130. The water storage device 500 may communicate with the exhaust paths defined by the exhaust pipes 110 and 130.

Air containing moisture may exist inside the exhaust pipes 110 and 130. The air containing moisture may be condensed while passing through the exhaust pipes 110 and 130.

More specifically, the air may be heated by the heating device 60 included in the food waste disposer 1. The heating device 60 may heat the disposal device to evaporate water of food waste accommodated in the disposal device.

While the heated air flows along the exhaust pipes 110 and 130, temperature of the air may be lowered. The air of which the temperature has been lowered may contain moisture. The moisture may liquefy into a liquid state as the temperature is lowered. The moisture in the liquid state is referred to as condensate water.

The exhaust pipes 110 and 130 may be connected to the disposal device to guide air containing moisture.

The water storage device 500 may be a device configured to collect condensate water therein. The water storage device 500 may be positioned in a direction of gravity with respect to the exhaust pipes 110 and 130. The water storage container 530 may be positioned in the direction of gravity with respect to the exhaust pipes 110 and 130 such that condensate water generated in the exhaust pipes 110 and 130 are collected.

The condensate water positioned in the exhaust pipes 110 and 130 may move to the water storage device 500 by gravity, although not limited thereto. However, the food waste disposer 1 may include a component for moving condensate water to the water storage device 500.

The food waste disposer 1 may include the exhaust fan 140. The exhaust fan 140 may be coupled to the exhaust pipes 110 and 130 to move air containing moisture inside the disposal device to the exhaust pipes 110 and 130.

Referring to FIG. 12, the water storage device 500 may include the water storage container 530 that stores condensate water. A water storage space 530S may be defined to accommodate condensate water inside the water storage container 530. An inlet of the water storage space 530S is referred to as a water storage opening 530A.

The water storage container 530 may collect condensate water inside the exhaust pipes 110 and 130. The water storage container 530 may be separated outside the cover housings 12 and 13.

The water storage container 530 may have a substantially rectangular parallelepiped shape. The water storage opening 530A may be defined in one side of the rectangular parallelepiped. For example, the water storage container 530 may be a component having five sides because one side of the rectangular parallelepiped is the water storage opening 530A, although not limited thereto. However, the water storage container 530 may have any shape as long as the water storage container 530 is capable of accommodating condensate water.

The water storage container 530 may include a plastic material although not limited thereto. However, the water storage container 530 may include a metal material.

The water storage container 530 may be manufactured by an injection molding process, although not limited thereto. However, the water storage container 530 may be manufactured by an appropriate process depending on a material.

The water storage container 530 may be separated outside the cover housings 12 and 13 (see FIG. 9). Accordingly, the water storage container 530 may be easily washed. Because condensate water that is stored in the water storage container 530 is connected to the disposal device, the condensate water may be contaminated. Accordingly, the inside of the water storage container 530 may also be contaminated by the contaminated condensate water. Because the water storage container 530 is separable from the cover housings 12 and 13, the water storage container 530 may be maintained clean. In the case of the food waste disposer 1 used at home, hygiene may be more important because the food waste disposer 1 is located inside a house.

A direction in which the water storage container 530 is accommodated in the cover housings 12 and 13 is referred to as an accommodation direction D1. A direction in which the water storage container 530 is separated from the cover housings 12 and 13 is referred to as a separation direction D2. For example, the accommodation direction D1 may be the front direction. The separation direction D2 may be the rear direction.

A position at which the water storage container 530 is accommodated in the cover housings 12 and 13 is referred to as an accommodation position of the water storage container 530. A position at which the water storage container 530 is separated from the cover housings 12 and 13 is referred to as a separation position of the water storage container 530. A position between the accommodation position and the separation position is referred to as a transfer position. The transfer position may be a position at which at least a part of the water storage container 530 is accommodated in the cover housings 12 and 13.

In other words, the water storage container 530 may be located at the accommodation position at which the water storage container 530 is located inside the cover housings 12 and 13 and is in contact with a sensor module 700. The water storage container 530 may be located at the separation position at which the water storage container 530 is located outside the cover housings 12 and 13.

The water storage container 530 may be in contact with the sensor module 700 at the accommodation position.

The water storage container 530 may include a container gripping portion 533 to allow a user to easily take the water storage container 530 out of the cover housings 12 and 13. The container gripping portion 533 may be positioned at a side portion of the water storage container 530 in the separation direction D2. The container gripping portion 533 may have a shape that is easily gripped by a user. The container gripping portion 533 may be positioned at an upper portion of the water storage container 530. A gripping recess 533S that is recessed toward the water storage space 530S may be provided below the container gripping portion 533. A user may put his/her hand into the gripping recess 533S, grip the container gripping portion 533, and take the water storage container 530 out of the cover housings 12 and 13.

The water storage container 530 may include a gasket contact portion 532 positioned on an edge of the water storage opening 530A. The gasket contact portion 532 may be a component that is in contact with a gasket 520 which will be described below. This will be described with reference to the related drawing, below.

While the water storage container 530 is spaced from the sensor module 700, condensate water inside the water storage container 530 may be prevented from leaking out.

The water storage device 500 may include the water storage cover 510 configured to cover the water storage container 530. The water storage cover 510 may be a component capable of covering the water storage space 530S of the water storage container 530. In other words, the water storage cover 510 may be a component capable of covering the water storage opening 530A of the water storage container 530.

The water storage cover 510 may be connected to the exhaust pipes 110 and 130. Condensate water generated in the exhaust pipes 110 and 130 may move to the water storage container 530 through the water storage cover 510.

The water storage cover 510 may communicate with the outside of the cover housings 12 and 13. Accordingly, air passed through the exhaust paths in the exhaust pipes 110 and 130 may move toward the filter assembly 150 (see FIG. 4).

The water storage cover 510 may include a plastic material, although not limited thereto. However, the water storage cover 510 may include a metal material.

The water storage cover 510 may be formed by injection molding, although not limited thereto. However, the water storage cover 510 may be formed by an appropriate process such as a press process.

The water storage cover 510 may include a water storage cover main body 511. The water storage cover main body 511 may be a component that defines a main appearance of the water storage cover 510.

The water storage cover 510 may include an exhaust pipe connecting portion 514 extending from the water storage cover main body 511. The exhaust pipe connecting portion 514 may be a component connected to the exhaust pipes 110 and 130.

The exhaust pipe connecting portion 514 may have a bent shape. The exhaust pipes 110 and 130 may extend vertically downward. It may be difficult to locate the water storage container 530 directly below the exhaust pipes 110 and 130. To connect the exhaust paths to the water storage space 530S, the exhaust pipe connecting portion 514 may be bent from the exhaust pipes 110 and 130 toward the water storage container 530. For example, the exhaust pipe connecting portion 514 may have a pipe shape bent at a right angle.

The exhaust pipe connecting portion 514 may be formed separately from the water storage cover main body 511. The exhaust pipe connecting portion 514 may be coupled to the water storage cover main body 511 by a coupling member, although not limited thereto. However, the exhaust pipe connecting portion 514 and the water storage cover main body 511 may be integrated into one body.

An exhaust pipe connecting hole 514H that communicates with the exhaust pipes 110 and 130 may be defined in the exhaust pipe connecting portion 514.

The water storage cover 510 may include the filter installing portion 512 extending from the water storage cover main body 511. The filter installing portion 512 may be a component for coupling the water storage cover 510 with the filter assembly 150. A filter connecting hole 512H that communicates with the filter assembly 150 may be defined in the filter installing portion 512.

The filter installing portion 512 may extend toward the filter assembly 150. For example, the filter installing portion 512 may extend upward.

The filter installing portion 512 may have an elliptical cross section or a shape of which two opposing corners are rounded and the remaining opposing corners are long, although not limited thereto.

The water storage device 500 may include a filter sealing member 513 that surrounds the filter installing portion 512. Because condensate water may be contaminated, it may be necessary to prevent condensate water or foul odors from leaking out between the filter installing portion 512 and the filter assembly 150. The filter sealing member 513 may seal between the filter installing portion 512 and the filter assembly 150.

The filter installing portion 512 may have an elastic material. For example, the filter installing portion 512 may have a rubber material.

The water storage cover 510 may include a cover flange 515 bent toward the water storage housing. The cover flange 515 may be positioned to correspond to an edge of the water storage cover 510.

The water storage device 500 may include the water storage housing 540 that accommodates the water storage container 530. A water storage container accommodating space 540S in which the water storage container 530 is accommodated may be defined in the water storage housing 540.

The water storage housing 540 may be a component surrounding the water storage container 530. However, because the water storage cover 510 covers the water storage opening 530A of the water storage container 530, the water storage housing 540 may cover remaining sides of the water storage container 530, not surrounded by the water storage cover 510.

The water storage container 530 may be separable from the water storage housing 540. An accommodating opening 540A may be defined to separate the water storage container 530 from the water storage housing 540. The accommodating opening 540A may be defined in the separation direction D2. For example, the accommodating opening 540A may be defined in a rear side of the water storage housing 540.

One side of the water storage housing 540 may be covered by the water storage cover 510. The water storage cover 510 may cover the water storage housing 540 and the water storage container 530 together.

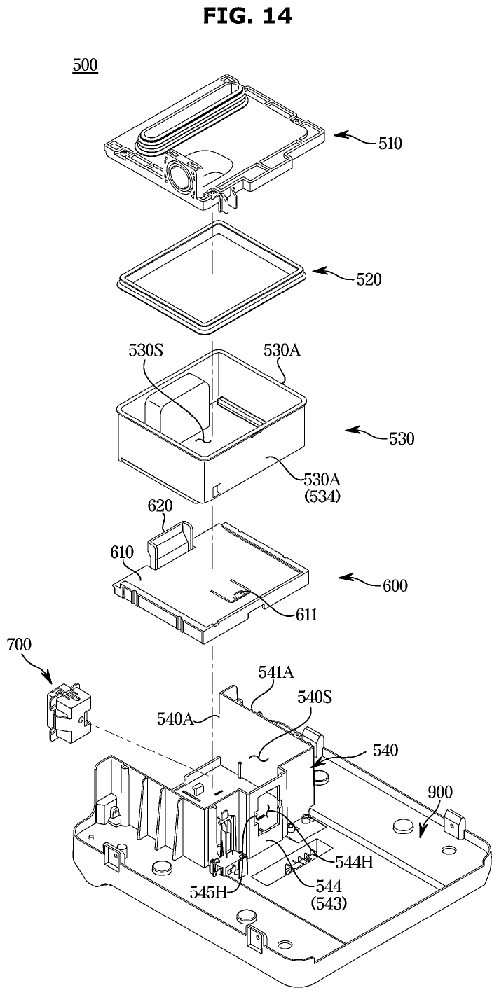

The water storage housing 540 may have a substantially rectangular parallelepiped shape. However, the side covered by the water storage cover 510 may be defined as an installing opening 541A (see FIG. 14). The side to which the water storage container 530 moves may be defined as the accommodating opening 540A. That is, the water storage housing 540 may have a rectangular parallelepiped shape of which two sides open.

While the water storage container 530 is at the accommodation position, the water storage container 530 may be positioned between the water storage cover 510 and the water storage housing 540.

The water storage housing 540 may be coupled to the water storage cover 510. The water storage cover 510 may be coupled to the water storage housing 540 by a coupling member.

The water storage housing 540 may have a plastic material. However, the water storage housing 540 may have a metal material, although not limited thereto.

The water storage housing 540 may be formed by an injection molding process, although not limited thereto.

The water storage housing 540 may include side water storage housings 542 that define side surfaces. For example, the side water storage housings 542 may be respectively positioned at left and right sides of the water storage housing 540. Each of the side water storage housings 542 may have a wall shape extending toward the water storage cover 510. For example, the side water storage housings 542 may extend upward.

The water storage housings 540 may include an opposing housing wall 543 positioned in the direction in which the water storage container 530 is accommodated. The opposing housing wall 543 may be positioned between the side water storage housings 542 positioned at the left and right sides. For example, the opposing housing wall 543 may be positioned in a front side of the water storage housing 540.

The opposing housing wall 543 may have a wall shape that substantially extends along a direction in which the side water storage housings 542 extend. For example, the opposing housing wall 543 may extend upward.

The opposing housing wall 543 may include a module inserting portion 544 on which the sensor module 700 is mounted. This will be described with reference to the related drawings, below.

The water storage device 500 may include the base housing 900. That is, the base housing 900 may be included in the housing 10 and simultaneously included in the water storage device 500. The base housing 900 may be a component that defines a lower appearance of the food waste disposer 1.

The base housing 900 may be integrated into the water storage housing 540. The base housing 900 may be connected to the water storage housing 540. The water storage housing 540 may be coupled to one side of the base housing 900.

The base housing 900 may be positioned below the water storage housing 540. The base housing 900 may define one side of the water storage housing 540. The base housing 900 may define a lower appearance of the water storage housing 540. The accommodating space 540S in which the water storage container 530 is accommodated may be defined by the water storage housing 540, the base housing 900, and the water storage cover 510. Also, the accommodating opening 540A may be defined by the water storage housing 540, the base housing 900, and the water storage cover 510, although not limited thereto.

However, the base housing 900 may be spaced from the water storage housing 540. The water storage housing 540 may be positioned in the direction of gravity with respect to the exhaust pipes 110 and 130 to collect condensate water generated in the exhaust pipes 110 and 130. Accordingly, the water storage housing 540 may be positioned in a lower portion of the food waste disposer 1. To locate the water storage housing 540 inside the cover housings 12 and 13, the water storage housing 540 may be supported. The water storage housing 540 and the base housing 900 may be positioned in the lower portion of the food waste disposer 1. Accordingly, the base housing 900 may support the water storage housing 540.

To easily separate the water storage container 530 from the water storage housing 540, the water storage housing 540 may be positioned in the rear portion of the food waste disposer 1. Accordingly, the water storage housing 540 may be coupled to a rear portion of an upper side of the base housing 900.

The water storage housing 540 may include a water storage housing supporting rib 541 that supports sides of the water storage housing 540 to enhance strength.

The base housing 900 may have a substantially flat shape.

The base housing 900 may include a plurality of ribs on an inner portion to reduce weight and enhance strength. The plurality of ribs may be positioned on a lower side of the base housing 900.

The base housing 900 may have a plastic material, although not limited thereto. However, the base housing 900 may have a metal material.

The base housing 900 may be manufactured by an injection molding process, although not limited thereto. However, the base housing 900 may be manufactured by an appropriate process depending on a material.

The water storage device 500 may include a water storage housing door 550 configured to open or close the accommodating opening 540A.

The water storage housing door 550 may define an appearance of the food waste disposer 1. Accordingly, components such as the water storage container 530 may be prevented from being exposed to the outside, thereby improving aesthetics of the food waste disposer 1.

The water storage housing door 550 may be coupled to the base housing 900. The water storage housing door 550 may be rotatably coupled to the base housing 900 to open or close the accommodating opening 540A, although not limited thereto. The water storage housing 540 may be slidingly coupled to the base housing 900.

The water storage housing door 550 may pivot about a water storage door rotation shaft 550I. The water storage door rotation shaft 550I may be located at a lower position with respect to the water storage door 550. Accordingly, the water storage housing door 550 may rotate downward to be prevented from being closed by gravity.

The water storage housing door 550 may include a plastic material, although not limited thereto. The water storage housing door 550 may include a metal material.

The water storage housing door 550 may be formed by an injection molding process, although not limited thereto. The water storage housing door 550 may be formed according to an appropriate process depending on a material.

The water storage housing door 550 may include a gripping portion 551 that protrudes to be gripped by a user.

The gripping portion 551 may be positioned in an upper portion of the water storage housing door 550. Accordingly, a user may easily grip the water storage housing door 550 without having to extend his/her hand further toward a floor.

The water storage device 500 may include a locking device 600 configured to limit a movement of the water storage container 530.

The locking device 600 may be positioned to be in contact with the water storage container 530.

While the water storage container 530 is limited in movement by the locking device 600, the water storage container 530 may be sealed with the water storage cover 510.

The locking device 600 may include a supporting plate 610 configured to support the water storage container 530.

The supporting plate 610 may be coupled to the water storage container 530 and positioned between the water storage container 530 and the base housing 900.

While the water storage container 530 moves from an unlocked position to a locked position, a supporting portion may press the supporting plate to move the water storage container.

The supporting plate 610 may support a lower side of the water storage container 530, although not limited thereto. However, the supporting plate 610 may be located at any position capable of supporting the water storage container 530. The supporting plate 610 may support upper, left, right, front, and rear sides of the water storage container 530.

The supporting plate 610 may have a flat plate shape, although not limited thereto. However, the support plate 610 may have a shape capable of evenly pushing a lower surface of the water storage container 530. For example, the supporting plate 610 may include a shape that protrudes toward the water storage container 530 symmetrically with respect to a center of the water storage container 530.

The supporting plate 610 may include a plastic material.

The supporting plate 610 may be formed by an injection molding process.

While the water storage container 530 moves from the locked position to the unlocked position, the water storage container 530 may move together with the supporting plate 610.

While the water storage container 530 is separated outside the cover housings 12 and 13, the water storage container 530 may slidingly move relative to the supporting plate 610.

The locking device 600 may include a locker 620 coupled to the supporting plate 610.

The locker 620 may rotate on a locker rotating shaft 620I.

The locker 620 may be configured to move the supporting plate 610. The locker 620 may move the supporting plate 610 by rotating to push the base housing 900. Thereby, the water storage container 530 may move toward the gasket 520. Accordingly, a user may easily change a position of the water storage container 530 by operating the locker 620 exposed to the outside, although not limited thereto. However, the locker 620 may have any configuration capable of moving the supporting plate 610. For example, the locker 620 may include a motor and a lifting device that are controllable from the outside.

The locker 620 may have a plastic material.

The locker 620 may be formed by an injection molding process.

The locking device 600 may include a sub locker 630 coupled to the supporting plate 610.

The sub locker 630 may be a component corresponding to the locker 620.

Particularly, referring to FIG. 13, the water storage device 500 may include the sensor module 700. The sensor module 700 may include a water level sensor 710 (not shown). The sensor module 700 may be a component for sensing by the water level sensor 710.

The water level sensor 710 may be a sensor that outputs a signal corresponding to an amount of condensate water stored in the water storage container 530. This will be described together with the related drawing, below.

The sensor module 700 may be installed in the water storage housing 540. The sensor module 700 may be coupled to the opposing housing wall 543 of the water storage housing 540. The sensor module 700 may be coupled to the module inserting portion 544 of the opposing housing wall 543. For example, the sensor module 700 may be coupled to a front portion of the water storage housing 540.

The sensor module 700 may be opposite to a surface defined in the direction in which the water storage container 530 is inserted from the separation position to the accommodation position.

While the water storage container 530 is at the accommodation position, the water level sensor 710 may output a signal related to a water level of the water storage container 530.

The sensor module 700 may include the water level sensor 710 configured to output a signal related to a water level of condensate water collected in the water storage container 530 while the sensor module 700 is adjacent to the water storage container 530.

The water level sensor 710 may be positioned inside the cover housings 12 and 13 and configured to output a signal related to a water level of condensate water collected in the water storage container 530 while the water level sensor 710 is in contact with the water storage container 530.

The water storage device 500 may include an installation sensor 570. The installation sensor 570 may be configured to output a corresponding signal when the water storage device 500 is at the accommodation position.

The installation sensor 570 may include a micro switch. The micro switch may be a sensor that outputs a signal when the sensor is pressed.

The installation sensor 570 may be coupled to the base housing 900.

The installation sensor 570 may be adjacent to the water storage housing 540.

The water storage device 500 may include an installation lever 571 to press the installation sensor 570. While the installation lever 571 is pressed by the water storage container 530, the installation lever 571 may press the installation sensor 570.

The installation lever 571 may have a plastic material, although not limited thereto. However, the installation lever 571 may have a metal material.

The installation lever 571 may be formed by an injection molding process, although not limited thereto. However, the installation lever 571 may be formed by an appropriate process depending on a material.

Hereinafter, the water storage device 500 will be described in more detail.

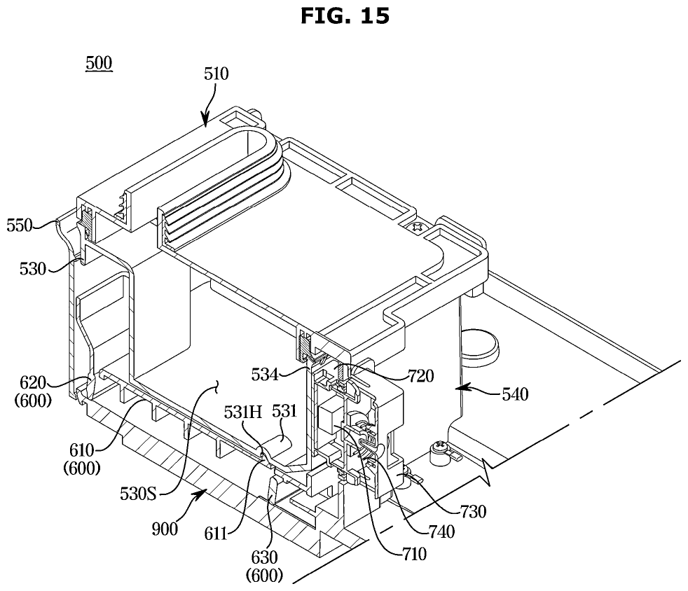

FIG. 14 is an exploded view of the water storage device 500 of the food waste disposer 1 shown in FIG. 13. FIG. 15 is a cross-sectional perspective view showing a cross section of the food waste disposer 1 shown in FIG. 13.

The water storage device 500 according to an embodiment of the disclosure will be described in more detail with reference to FIGS. 14 and 15.

The water storage device 500 may include the gasket 520. The gasket 520 may be a component capable of sealing between the water storage cover 510 and the water storage container 530.

The gasket 520 may be positioned between the water storage container 530 and the water storage cover 510 to seal between the water storage container 530 and the water storage cover 510 while the water storage container 530 is at the locked position.

The gasket 520 may be positioned between the water storage cover 510 and the water storage container 530. The gasket 520 may be positioned along a gap defined between the water storage cover 510 and the water storage container 530.

The gasket 520 may extend along the water storage opening 530A. For example, the gasket 520 may have a quadrangular ring shape.

The gasket 520 may be coupled to the water storage cover 510. The water storage cover 510 may include a groove for accommodating the gasket 520. The gasket 520 may be positioned to be in contact with a gasket contact portion 532 of the water storage container 530.

The gasket contact portion 532 of the water storage container 530 may extend outward from the water storage space 530S. The gasket contact portion 532 may be bent and extend.

A thickness of a portion of the gasket 520, which the gasket contact portion 532 is in contact with, may be smaller than a thickness of another portion of the gasket 520, which is in contact with the water storage cover 510. Accordingly, the gasket 520 may be stably coupled to the water storage cover 510 and easily deformed while contacting the water storage container 530.

The gasket 520 may have a deformable elastic material. For example, the gasket 520 may be a rubber material. Accordingly, while the water storage container 530 and the water storage cover 510 are pressed toward the gasket 520, the gasket 520 may be deformed. Accordingly, the gasket 520 may fill the gap defined between the water storage container 530 and the water storage cover 510.

The gasket 520 may be formed by an injection molding process, although not limited thereto. However, the gasket 520 may be formed by an appropriate process depending on a material.

The water storage housing 540 may include the opposing housing wall 543 positioned in the accommodation direction D1 of the water storage container 530.

The opposing housing wall 543 may include the module inserting portion 544 that is depressed in the accommodation direction D1. In the module inserting portion 544, a module inserting hole 544H defined to pass the sensor module 700 through may be provided.

The module inserting hole 544H may have a shape corresponding to the sensor module 700. The module inserting hole 544H may have a rectangular shape.

The module inserting hole 544H may be formed by cutting out.

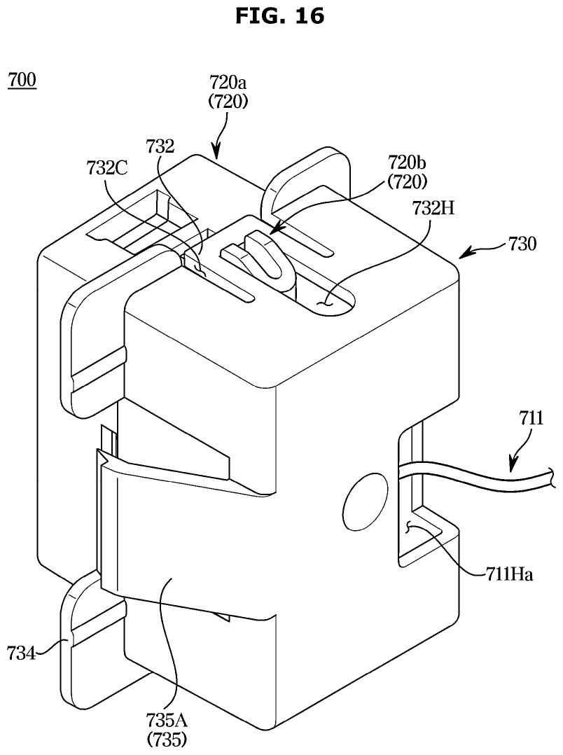

The module inserting hole 544H may be provided with a protrusion inserting hole 545H defined such that a supporting protrusion 735 (see FIG. 16) of the sensor module 700 is inserted in the protrusion inserting hole 545H. The protrusion inserting hole 545H may be defined to correspond to the supporting protrusion 735. The protrusion inserting hole 544H may have a shape configured such that after the supporting protrusion 735 is inserted in the protrusion inserting hole 545H, the supporting protrusion 735 does not easily escape from the protrusion inserting hole 545H in an opposite direction of the insertion direction.

The module inserting portion 544 may include a module installing space 544S in which the sensor module 700 is rested.

The water storage housing 540 may include a stopper 611. The stopper 611 may be a component that prevents the water storage container 530 located at the accommodation position from further moving toward the opposing housing wall 543.

The stopper 611 may have a shape protruding toward the water storage container 530 while the water storage container 530 is at the accommodation position. The stopper 611 may be defined such that an angle of a surface in separation direction D2 of the stopper 611 with respect to the base housing 900 is greater than an angle of another surface in accommodation direction D1 of the stopper 61 with respect to the base housing 900. For example, the stopper 611 may be defined such that the surface in separation direction D2 of the stopper 611 is substantially perpendicular to the base housing 900. The stopper 611 may be defined such that the other surface in accommodation direction D1 of the stopper 611 has an angle of substantially 10 degrees to 80 degrees with respect to the base housing 900.

Accordingly, when the water storage container 530 moves in the accommodation direction and comes in contact with the stopper 611, the stopper 611 may prevent the water storage container 530 from further moving in the accommodation direction D1. Also, while the water storage container 530 moves in the separation direction D2, the water storage container 530 may be prevented from being limited in movement by the stopper 611.

The stopper 611 may move in a direction that is perpendicular to the accommodation direction D1. For example, the stopper 611 may move in an up-down direction.

The stopper 611 may have elasticity. One end of the stopper 611 may be a fixed end and another end of the stopper 611 may be a free end. Accordingly, the stopper 611 may be restored to an original position after moving.

The stopper 611 may have a substantially quadrangular shape. One corner may be fixed, and remaining three corners may be free. A slit surrounding the three corners which are free may be provided. A protrusion may be positioned at a free corner that is opposite to the fixed corner.

The water storage container 530 may include a stopper accommodating groove (531H) forming portion that defines a stopper accommodating groove 531H to accommodate the stopper 611. The stopper accommodating groove 531H may have a shape corresponding to the protruding shape of the stopper 611.

Particularly, a configuration of the water storage device 500 will be again described with reference to FIG. 14.

The water storage housing 540 having the accommodating space 540S may be positioned on the base housing 900.

The locking device 600 may be accommodated inside the water storage housing 540.

The sensor module 700 may be positioned by penetrating the opposing housing wall 543 of the water storage housing 540.

The water storage container 530 having the water storage space 530S may be positioned on the locking device 600. The water storage container 530 may have an opposing container wall 534 that faces the sensor module 700. The opposing container wall 534 may have an opposing container surface 534A that comes in contact with the sensor module 700.

The opposing container surface 534A may face the sensor module 700 while the water storage container 530 is at the accommodation position.

The water storage cover 510 may be positioned to cover the water storage space 530S. The water storage cover 510 may be coupled to the water storage housing 540.

The gasket 520 may be positioned along the edge of the water storage cover 510. The gasket 520 may be in contact with the water storage container 530.

The stopper 611 may be rested in the stopper accommodating portion 531 while the water storage container 530 is at the accommodation position. Therefore, the water storage container 530 may be located at a preset position. For example, the preset position at which the water storage container 530 is accommodated may be a position at which the water storage container 530 is in contact with the sensor module 700.

While the water storage container 530 is at the accommodation position, the opposing container wall 534 of the water storage container 530 may be in contact with the sensor module 700. The opposing container wall 534 may press the sensor module 700. Accordingly, storage container 530 may become closer to the water level sensor 710 included in the sensor module 700.

The sensor module 700 may be coupled to the water storage housing 540.

The sensor module 700 may be coupled to the opposing housing wall 543 of the water storage housing 540. Accordingly, while the water storage housing 540 moves from the separation position to the accommodation position, the sensor module 700 may face the water storage housing 540 in the accommodation direction D1 with respect to the water storage housing 540. Therefore, while the water storage housing 540 moves in the accommodation direction D1, the water storage housing 540 may press the sensor module 700.

The locking device 600 may limit a movement of the water storage container 530 while the water storage container 530 is in the accommodation position. The locking device 600 may move from the unlocked position that allows a movement of the water storage container 530 from the accommodation position to the separation position, to the locked position that limits a movement of the water storage container 530.

That is, the water storage container 530 at the unlocked position may be allowed to move. The water storage container 530 at the locked position may be limited in moving. While the water storage container 530 moves from the unlocked position to the locked position, the water storage container 530 may move toward the water storage cover 510.

While the locking device 600 is at the locked position, the water storage container 530 may be in close contact with the gasket 520. While the water storage container 530 is in close contact with the gasket 520, negative pressure may occur between the water storage container 530 and the gasket 520. Accordingly, the water storage container 530 may be in close contact with the gasket 520.

According to a movement from the unlocked position to the locked position, the locking device 600 may move the water storage container 530 toward the gasket 520. The locking device 600 may move the water storage container 530 toward the water storage cover 510, although not limited thereto. However, the locking device 600 may move the water storage container 530 to an appropriate position to limit a movement of the water storage container 530.

A user may move the supporting plate 610 by operating the locker 620. While the supporting plate 610 moves, the water storage container 530 may move toward the water storage cover 510.

The gasket 520 may be in close contact with the water storage cover 510. Accordingly, no gap may be made between the water storage container 530 and the gasket 520 and between the gasket 520 and the water storage cover 510. The water storage container 530 may be covered by the water storage cover 510 configured to cover the water storage opening 530A (see FIG. 14). The water storage cover 510 may be connected to the exhaust pipes 110 and 130 (see FIG. 4) at one side and connected to the filter assembly 150 (see FIG. 4) at another side that is not the one side. That is, while the locking device 600 is at the locked position, the water storage container 530 may be positioned in such a way as to prevent a path from the exhaust pipes 110 and 130 to the filter assembly 150 from communicating with the outside. Air inside the exhaust pipes 110 and 130 of the food waste disposer 1 may contain foul odors generated in the disposal device (see FIG. 4). Accordingly, in the case in which the path from the exhaust pipes 110 and 130 to the filter assembly 150 communicates with another path than a designated path, foul odors may be discharged along an undesignated path. Particularly, because the food waste disposer 1 is generally used indoor, in the case in which the path from the exhaust pipes 110 and 130 to the filter assembly 150 is not sealed, foul odors may be emitted indoor. To create a comfortable indoor environment, the path from the exhaust pipes 110 and 130 to the filter assembly 150 may need to be sealed.

Hereinafter, the sensor module 700 will be described in more detail.

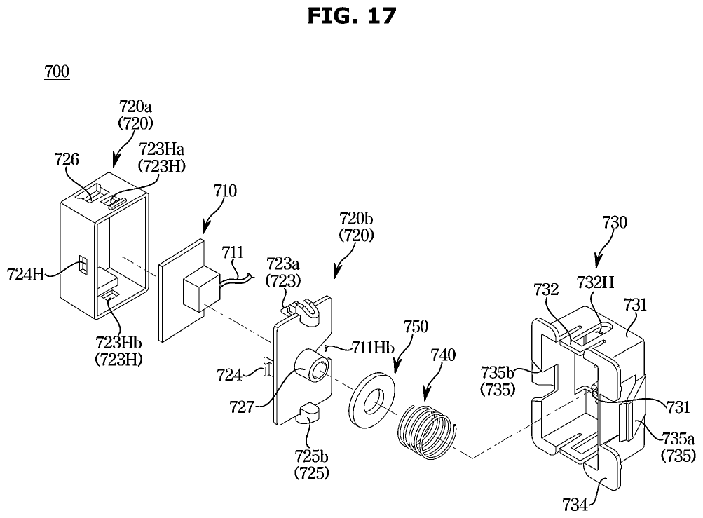

FIG. 16 is a perspective view showing the sensor module 700 of the food waste disposer 1 shown in FIG. 13. FIG. 17 is an exploded view of the sensor module 700 of the food waste disposer 1 shown in FIG. 16.

A configuration of the sensor module 700 according to an embodiment of the disclosure will be described with reference to FIGS. 16 and 17.

The sensor module 700 may mean a component related to the water level sensor 710.

The sensor module 700 may include the water level sensor 710. The water level sensor 710 may be a component capable of outputting a signal in correspondence to a water level of condensate water accommodated in the water storage container 530.

The water level sensor 710 may detect a water level of condensate water in a non-contact manner. That is, the water level sensor 710 may detect a water level of condensate water without contacting the condensate water. The water level sensor 710 may output a signal corresponding to a water level of condensate water according to a change in capacitance of a component which the water level sensor 710 contacts. That is, the water level sensor 710 may be a capacitive sensor. Accordingly, because the water level sensor 710 is not in contact with water, corrosion may be delayed, although not limited thereto. However, the water level sensor 710 may include a component that is in contact with condensate water to obtain the following effect.

In other words, the water level sensor 710 may be in contact with an outer surface of the water storage container 530, and output a signal related to a water level of condensate water inside the water storage container 530 according to a change in capacitance of the water storage container 530.

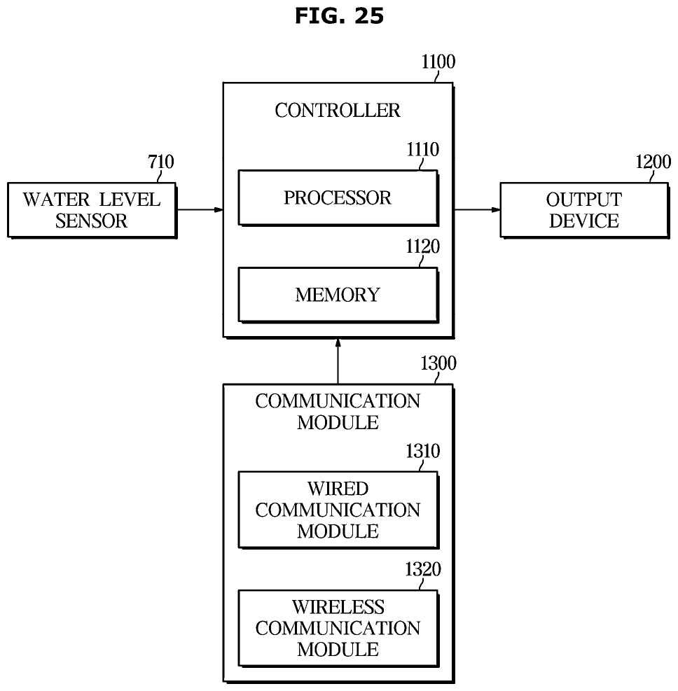

The water level sensor 710 may be electrically connected to the processor 1110 (see FIG. 25) which will be described below.

The water level sensor 710 may include a wire 711 that is connected to the processor 1110.

The sensor module 700 may include cases 720 and 730 that accommodate the water level sensor 710.

While the water storage container 530 is at the accommodation position, the water level sensor 710 may be prevented from being located in the water storage space 530S. Accordingly, the water level sensor 710 may not be in contact with condensate water. In the case in which the water level sensor 710 is in contact with condensate water, the water level sensor 710 may be contaminated. Accordingly, the water level sensor 710 may have difficulty in sensitive detection. The lifespan of the water level sensor 710 may be shortened.

The cases 720 and 730 may include a first case 720 that accommodates the sensor module 700, and a second case 730 coupled to the first case 720.

The water level sensor 710 may be located inside the first case 720.

The second case 730 may be coupled to the water storage housing 540.

The first case 720 may be coupled to the second case 730 in such a way as to move forward and backward relative to the second case 730.

The first case 720 may include a first part case 720a of which one side opens to accommodate the water level sensor 710 therein, and a second part case 720b configured to cover the open side of the first part case 720a.

In other words, the first case 720 may include the first part case 720a having an opening where the water level sensor 710 is rested. The first case 720 may include the second part case 720b detachably coupled to the first part case 720a to prevent the water level sensor 710 from being detached from the first part case 720a. Accordingly, the water level sensor 710 may be easily accommodated in the first case 720.

In other words, the first case 720 may include the first part case 720a. The first part case 720a may include an opposing module portion 721 configured to face the water storage container 530 while the water storage container 530 is at the accommodation position. The opposing module portion 721 may include an opposing module surface 721A that faces the water storage container 530.

The opposing module surface 721A may face the opposing container surface 534A to be in close contact with the water storage container 530 while the water storage container 530 is at the accommodation position, and the opposing module surface 721A may correspond to the opposing container surface 534A. That is, the opposing module surface 721A may have the same slope as the opposing container surface 534A.

The water level sensor 710 may be in contact with the first part case 720a at a side of the first part case 720a toward the water storage container 530. That is, the water level sensor 710 may be in contact with the opposing module portion 721. The opposing module portion 721 may have a shape corresponding to the water level sensor 710. In the case in which the water level sensor 710 has a quadrangular flat plate shape, the opposing module portion 721 may also have a quadrangular flat plate shape. Accordingly, the water level sensor 710 may be prevented from being separated from the first part case 720a.

The first part case 720 may have a substantially rectangular parallelepiped shape. Accordingly, the water level sensor 710 may be accommodated in the first part case 720, although not limited thereto. However, the first part case 720a may have a shape corresponding to the water level sensor 710. For example, in the case in which the water level sensor 710 has a circular plate shape, the first part case 720a may have a circular shape at the corresponding part.

One side of six sides of the rectangular parallelepiped of the first part case 720a may be provided as an opening.

The first part case 720a may have a plastic material.

The first part case 720a may be formed by an injection molding process.

An extension hook hole 723H may be defined in the first part case 720a. An extension hook 723 of the second part case 720b which will be described below may be inserted into the extension hook hole 723H to couple the first part case 720a to the second part case 720b.

A plurality of extension hook holes 723H may be provided. The plurality of extension hook holes 723H may include a first extension hook hole 723Ha and a second extension hook hole 723Hb respectively located at upper and lower sides of the first part case 720a. Therefore, the first part case 720a may be stably coupled to the second part case 720b, although not limited thereto. However, the extension hook holes 723H may be respectively located at opposing ones among sides surrounding the opposing module portion 721 of the first part case 720a. For example, the extension hook holes 723H may be respectively defined at left and right sides of the first part case 720a.

A coupling hook hole 724H may be defined in the first part case 720a. A coupling hook 724 of the second part case 720b which will be described below may be inserted in the coupling hook hole 724H to couple the first part case 720a to the second part case 720b.

A plurality of coupling hook holes 724H may be provided. The plurality of coupling hook holes 724H may include a first coupling hook 724a and a second coupling hook 724b respectively located at the right and left sides, although not limited thereto. However, the coupling hook holes 724H may be respectively located at opposing ones among the sides surrounding the opposing module portion 721 of the first part case 720a. Also, the coupling hook holes 724H may be prevented from being positioned in the sides of the first part case 720a, in which the first extension hook hole 723Ha and the second extension hook hole 723Hb are positioned. For example, the extension hook holes 723H may be respectively defined in the upper and lower sides of the first part case 720a.

The first case 720 may include the second part case 720b. The second part case 720b may be a component that is coupled to the first part case 720a and accommodates the water level sensor 710 therein.

The second part case 720b may cover the opening defined in the second part case 720a. The second part case 720b may be coupled to the first part case 720a at the opening defined in the first part case 720a.

The second part case 720b may have a substantially flat plate shape, although not limited thereto. However, the second part case 720b may have a shape corresponding to the opening of the first part case 720a. For example, in the case in which the opening defined in the first part case 720a has a circular shape, the second part case 720b may have a hemispherical shape.

The second part case 720b may have a plastic material.

The second part case 720b may be formed by an injection molding process.

The second part case 720b may include a second part case main body 722. The second part case main body 722 may define an appearance of the second part case 720b.

The second part case main body 722 may have a flat plate shape.

The second part case 720b may include the extension hook 723 inserted in the extension hook hole 723H. The extension hook 723 may be a component that is inserted in the extension hook hole 723H to couple the first part case 720a to the second part case 720b.

The extension hook 723 may extend from the second part case main body 722.

The extension hook 723 may extend toward the first case 720. The extension hook 723 may extend toward the rear direction, although not limited thereto. However, the extension hook 723 may extend toward the extension hook hole 723H.

The extension hook 723 may have a hook shape that protrudes outward from the second part case 720b, although not limited thereto. However, the extension hook 723 may have a shape inserted into and fixed to the extension hook hole 723H. For example, the extension hook 723 may protrude toward inside of the second part case 720b and be inserted in the extension hook hole 723H.

The extension hook 723 may be inclined such that the end becomes sharper as the extension hook 723 extends toward the extension hook hole 723H. The extension hook 723 may have a surface inclined downward toward the rear portion. Accordingly, the extension hook 723 may be easily inserted into the extension hook hole 723H.

The extension hook 723 may be continuously inclined, although not limited thereto. However, the extension hook 723 may be inclined to correspond to a portion that is inserted in the extension hook hole 723H.

The extension hook 723 may have a step in an opposite direction of a direction toward the first part case 720a in the hook shape. The extension hook 723 may be prevented from being separated from the extension hook hole 723H by the step.

The extension hook 723 may be elastically movable with respect to the second part case 720b. The extension hook 723 may be elastically deformable. Accordingly, a user may easily insert the extension hook 723 into the extension hook hole 723H by moving a position of the extension hook 723.

A plurality of extension hooks 723 may be provided. The plurality of extension hooks 723 may include a first extension hook 723a configured to be inserted into the first extension hook hole 723Ha and a second extension hook 723b configured to be inserted into the second extension hook hole 723Hb.

The first extension hook hole 723Ha may be positioned in an upper side of the second part case main body 722, and the second extension hook hole 723Hb may be positioned in a lower side of the second part case main body 722, although not limited thereto. The first extension hook 723a and the second extension hook 723b may be positioned to respectively correspond to the first extension hook hole 723Ha and the second extension hook hole 723Hb.

The second part case 720b may include the coupling hook 724. The coupling hook 724 may be a component inserted in the coupling hook hole 724H.

The coupling hook 724 may extend from the second part case main body 722.

The coupling hook 724 may extend toward the first case 720. The coupling hook 724 may extend toward the rear direction, although not limited thereto. The coupling hook 724 may extend toward the coupling hook hole 724H.

The coupling hook 724 may have a hook shape protruding outward from the second part case 720b, although not limited thereto. However, the coupling hook 724 may have a shape that is inserted into the coupling hook hole 724 and fixed. For example, the coupling hook 724 may protrude toward inside of the second part case 720b and be inserted in the coupling hook hole 724H.

The coupling hook 724 may be inclined such that the end becomes sharper toward the coupling hook hole 724H. The coupling hook 724 may have a surface that is inclined downward toward the rear direction. Accordingly, the coupling hook 724 may be easily inserted into the coupling hook hole 724H.

The coupling hook 724 may be continuously inclined, although not limited thereto. The coupling hook 724 may be inclined to correspond to a portion that is inserted into the coupling hook hole 724H.

The coupling hook 724 may have a step in the opposite direction of the direction toward the first part case 720a in the hook shape. The coupling hook 724 may be prevented from being separated from the coupling hook hole 724H by the step.

The coupling hook 724 may be elastically movable with respect to the second part case 720b. The coupling hook 724 may be elastically deformable. Therefore, a user may easily insert the coupling hook 724 into the coupling hook hole 724H by moving a position of the coupling hook 724.

A plurality of coupling hooks 724 may be provided. The plurality of coupling hooks 724 may include the first coupling hook 724a configured to be inserted in a hole for the first coupling hook 724a, and the second coupling hook 724b configured to be inserted in a hole for the second coupling hook 724b.

The hole for the first coupling hook 724a may be positioned in a right side of the second part case main body 722, and the hole for the second coupling hook 724b may be positioned in a left side of the second part case main body 722, although not limited thereto. The first coupling hook 724a and the second coupling hook 724b may be positioned to correspond to the hole for the first coupling hook 724a and the hole for the second coupling hook 724b.

The coupling hook 724 may be formed as a single piece. A wire groove 711Hb may be defined in a portion where the above-mentioned hole for the second coupling hook 724b is positioned.

The wire groove 711Hb may be defined in the second part case 720b. The wire groove 711Hb may be a groove through which the wire 711 of the water level sensor 710 passes.

The wire groove 711Hb may be concave from the left side to the right side of the second part case main body 722, although not limited thereto. However, the wire groove 711Hb may be a component that is concave from a corner of the second part case main body 722 toward an inner side of the second part case main body 722. Also, the wire groove 711Hb may have a hole shape through which the wire 711 penetrates the second part case main body 722.

The wire groove 711Hb may have a tapered shape of which the end becomes narrower toward the inner portion of the second part case main body 722.

The second part case 720b may include a slit protrusion 725. The slit protrusion 725 may be a component that is inserted in a guide slit 732H which will be described below.

The slit protrusion 725 may be coupled to the second part case main body 722.

The slit protrusion 725 may extend from the second part case main body 722. The slit protrusion 725 may extend toward the guide slit 732H. The slit protrusion 725 may extend toward the front direction, although not limited thereto. However, the slit protrusion 725 may extend to be accommodated in the guide slit 732H.

The slit protrusion 725 may extend, at a position corresponding to the extension hook 73, in an opposite direction of a direction in which the extension hook 723 extends. The slit protrusion 725 may extend in the opposite direction of the extension direction of the extension hook 723. Therefore, the slit protrusion 725 may be supported by the extension hook 723. Accordingly, the slit protrusion 725 may be prevented from being damaged.

The slit protrusion 725 may have a hook shape protruding to the outside of the second part case 720b, although not limited thereto. However, the slit protrusion 725 may have a shape inserted in and fixed to the guide slit 732H. For example, the slit protrusion 725 may protrude toward the inside of the second part case 720b and be inserted in the guide slit 732H.

The slit protrusion 725 may be inclined such that the end becomes sharper toward the guide slit 732H. The slit protrusion 725 may have a surface inclined downward toward the front direction. Therefore, the slit protrusion 725 may be easily inserted into the guide slit 732H.

The slit protrusion 725 may be continuously inclined, although not limited thereto. However, the slit protrusion 725 may be inclined to correspond to a portion that is inserted into the guide slit 732H.

The slit protrusion 725 may have a step in the opposite direction of the direction toward the first part case 720a in the hook shape. The slit protrusion 725 may be prevented from being separated from the guide slit 732H by the step.

The guide slit 732H which will be described below may be longer than the slit protrusion 725 to move the slit protrusion 725. Accordingly, the slit protrusion 725 may be movable in the front-rear direction, although not limited thereto. The guide slit 732H may be defined to enable the first case 720 to slidingly move relative to the second case 730 in a direction in which the first case 720 is coupled to the second case 730.

The slit protrusion 725 may be elastically movable with respect to the second part case 720b. The slit protrusion 725 may be elastically deformable. Therefore, a user may easily insert the slit protrusion 725 into the guide slit 732H by moving a position of the slit protrusion 725.

A plurality of slit protrusions 725 may be provided. The plurality of slit protrusions 725 may include a first slit protrusion 725a configured to be inserted in the first guide slit 732Ha, and a second slit protrusion 725b configured to be inserted in the second guide slit 732Hb.

The first guide slit 732Ha may be positioned in the upper side of the second part case main body 722, and the second guide slit 732Hb may be positioned in the lower side of the second part case main body 722, although not limited thereto. However, the first slit protrusion 725a and the second slit protrusion 725b may be positioned to respectively correspond to the first guide slit 732Ha and the second guide slit 732Hb.

The second part case 720b may include a guide boss space 727S that protrudes to be coupled to a pressing damper 750 which will be described below.

The guide boss space 727S may protrude from the second part case main body 722 toward the first case 720.

The guide boss space 727S may be in a shape of a cylinder, although not limited thereto. However, the guide boss space 727S may have a shape corresponding to a shape of the pressing damper 750.

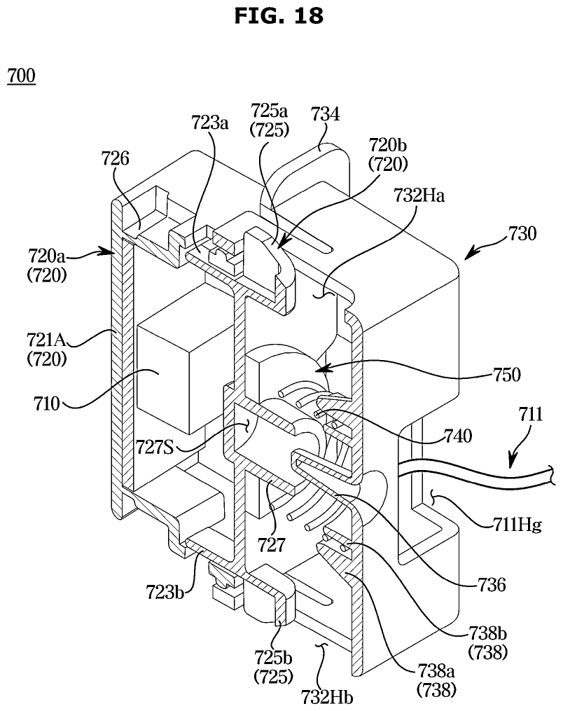

In a center area of the cylinder of the guide boss space 727S, a space (see FIG. 18) for the guide boss space 727S may be defined.

The sensor module 700 may include a second case 730. The second case 730 may be a component coupled to the first case 730 and defining an appearance of the sensor module 700.

An opening may be defined in one side of the first case 720. Other components may be accommodated in the first case 720 through the opening.

The first case 720 may have a substantially rectangular parallelepiped shape, although not limited thereto. However, the first case 720 may correspond to the shape of the second case 730 corresponding to the first case 720.

A side of the first case 720, which faces the second part case 720b, among six sides of the rectangular parallelepiped, may be configured to be defined as an opening. The opening may have a rectangular shape, although not limited thereto. However, the opening may have a shape corresponding to the shape of the second part case 720b.

The second case 730 may include a second case main body 731. The second case main body 731 may define an appearance of the second case 730.

The guide slit 732H may be defined such that the slit protrusion 725 is accommodated in the second case 730. The guide slit 732H may guide a movement of the slit protrusion 725 to enable the first case 720 to slidingly move relative to the second case 730.

That is, the slit protrusion 725 may include a slit protrusion 725 of which at least one portion is accommodated in the guide slit 732H to be guided by the guide slit 732H. Accordingly, a movement of the first case 720 may be guided.

The guide slit 732H may extend in the second case 730 in a direction from the separation position of the water storage container 530 toward the accommodation position. The guide slit 732H may be defined to extend in the front-rear direction.

The second case 730 may include a guide slit portion 732 to define the guide slit 732H.

The guide slit portion 732 may have a rectangular shape, although not limited thereto. However, the guide slit portion 732 may have a shape corresponding to the guide slit 732H to define the guide slit 732H.

A slit may be formed in at least one portion of the first case 720, surrounding the guide slit portion 732. The slit may be defined at left and right sides of the guide slit portion 732. The guide slit portion 732 may have a free end and a fixed end. The fixed end may be positioned in a front part of the guide slit portion 732. The free end may be positioned in a rear part of the guide slit portion 732. The free end may be positioned in a direction toward the slit protrusion 725. Accordingly, the guide slit portion 732 may move in such a way as to be elastically deformable. The guide slit portion 732 may move in the up-down direction.

While the slit protrusion 725 is inserted into the guide slit 732H, the guide slit portion 732 may move to the outside of the second case 730 to facilitate an insertion of the slit protrusion 725 into the guide slit 732H.

A plurality of guide slit portions 732 may be provided. The plurality of guide slit portions 732 may include a first guide slit portion 732 provided in the upper side and a second guide slit portion 732 provided in the lower side, although not limited thereto. However, the first guide slit portion 732 and the second guide slit portion 732 may be positioned to correspond to the first slit protrusion 725a and the second slit protrusion 725b.

While the first slit protrusion 725a is inserted into the first guide slit 732Ha, the first guide slit portion 732 may be pressed by the first slit protrusion 725a and move upward. After the first slit protrusion 725a is inserted into the first guide slit 732Ha, the first guide slit portion 732 may again move downward to be restored.

While the second slit protrusion 725b is inserted into the second guide slit 732Hb, the second guide slit portion 732 may be pressed by the second slit protrusion 725b and move downward. After the second slit protrusion 725b is inserted into the second guide slit 732Hb, the second guide slit portion 732 may again move upward to be restored.

While the water storage container 530 moves in the accommodation direction D1 from the separation position toward the accommodation position, the first case 720 may move to the position of the second case 730 spaced in the accommodation direction D1 from the position of the first case 720.

A slit movement groove 732c may be defined to surround the guide slit portion 732. The guide slit portion 732 may move by the slit movement groove 732c. Accordingly, the slit protrusion 725 may be easily accommodated in the guide slit 732H.

The second case 730 may include a supporting flange portion 734. The supporting flange portion 734 may be a component supported by the water storage housing 540 (see FIG. 15).

The supporting flange portion 734 may be in contact with the water storage housing 540. This will be described with reference to the related drawing, below.

The supporting flange portion 734 may extend toward the outside of the first case 720 along the opening. The supporting flange portion 734 may be bent along the edge of the second case 730 and extend outward from the second case 730.

The supporting flange portion 734 may be positioned on the same plane as that extending from an opening defined in the second case 730.

The supporting flange portion 734 may be provided at each of left and right sides of the second case 730. Accordingly, the supporting flange portion 734 may support the second case 730 in a balanced manner, although not limited thereto. However, the supporting flange portion 734 may be provided at both sides with respect to the first case 720.

The supporting flange portion 734 may extend from the left and right sides of the second case 730 to some parts of upper and lower sides of the second case 730. In the upper and lower sides of the second case 730, the first guide slit portion 732 and the second guide slit portion 732 may be positioned. Accordingly, the supporting flange portion 734 may be positioned not to overlap with the first guide slit portion 732 and the second guide slit portion 732.

The supporting flange portion 734 may be positioned not to overlap with the supporting protrusion 735 which will be described below. Because the supporting protrusion 735 is provided in the left or right side of the second case 730, the support flange portion 734 may be disconnected at the corresponding part.

The second case 730 may include the supporting protrusion 735. The supporting protrusion 735 may be a component that supports the water storage housing 540.

The supporting protrusion 735 may extend from the second case main body 731. The supporting protrusion 735 may protrude toward a left or right direction from the second case main body 731. The supporting protrusion 735 may substantially extend to the opening defined in the second case 730.

The supporting protrusion 735 may be coupled to the second case main body 731 in such a way as to have a slope with respect to the second case main body 731. The supporting protrusion 735 may easily penetrate the protrusion inserting hole 545H (see FIG. 14) defined in the module inserting portion 544H by the slope.

An end of the supporting protrusion 735 may share the same plane as that including the opening. Accordingly, the end may support the water storage housing 540.

A plurality of supporting protrusions 735 may be provided. The plurality of supporting protrusions 735 may include a first supporting protrusion 735a positioned at a left side of the second case main body 731, and a second supporting protrusion 735b positioned at a right side of the second case main body 731. Accordingly, the second case main body 731 may be supported in a balanced manner. However, the disclosure is not limited thereto, and the first supporting protrusion 735a and the second supporting protrusion 735b may be respectively positioned at opposite sides of the case main body 720 or 730.

The supporting protrusion 735 may have an inclined surface 735A inclined forward toward the center portion to be easily accommodated in a protrusion inserting hole 745H.

The inclined surface 735A may include a first inclined surface 735Aa and a second inclined surface 735Ab provided in the first supporting protrusion 735a.

In the second case 730, a wire hole 711Ha defined such that the wire 711 of the water level sensor 710 extends to the outside of the second case 730 may be defined. The wire hole 711Ha may be defined in a front part of the first case 720.

The sensor module 700 may include a pressing member 740. The pressing member 740 may be a component capable of moving the water level sensor 710 close to an object to be measured.

The pressing member 740 may be positioned between the first case 720 and the second case 730. The pressing member 740 may be positioned between the second part case 720b and the second case 730.

The pressing member 740 may be positioned to be compressed between the second part case 720b and the second case 730. The pressing member 740 may press both the second part case 720b and the second case 730 to move the second part case 720b and the second case 730 away from each other.

While the water storage container 530 is at the accommodation position, the pressing member 740 may press the cases 720 and 730 to indirectly press the water level sensor 710 toward the water storage container 530. Accordingly, because the pressing member 740 is not directly in contact with the water level sensor 710, the lifespan of the water level sensor 710 may increase.

The pressing member 740 may be configured such that the water level sensor 710 is pressed in a direction toward the water storage container 530 while the water storage container 530 is at the accommodation position. Accordingly, the water level sensor 710 may be attached closer to the water storage container 530.

The pressing member 740 may accommodate the guide boss space 727S. Accordingly, the pressing member 740 may be prevented from deviating from a preset position.

The pressing member 740 may be a spring, although not limited thereto. However, the pressing member 740 may be any component capable of pressing the first case 720 and the second case 730 in a direction of spacing the first case 720 and the second case 730 away from each other. For example, the pressing member 740 may have a shape of a rod extending in a transverse direction.

While the water storage container 530 is at the accommodation position, the pressing member 740 may be compressed to be positioned between the first case 720 and the second case 730 to elastically support the first case 720 in the direction toward the water storage container 530. Accordingly, while the water storage container 530 is at the accommodation position, the water level sensor 710 may be pressed closer to the water storage container 530. Accordingly, the water level sensor 710 may generate a signal by sensitively detecting a water level of condensate water in the water storage container 530.

The pressing member 740 may be a metal material.

The pressing member 740 may be formed by bending a wire.

The sensor module 700 may include the pressing damper 750. The pressing damper 750 may be a component for distributing pressure to an object pressed by the pressing member 740.

That is, the pressing damper 750 may include a pressing damper 750 positioned between the first case 720 and the pressing member 740 to evenly distribute pressure applied to the first case 720 by the pressing member 740.

The pressing damper 750 may be positioned between the pressing member 740 and the second part case 720b. Accordingly, by pressing the first part case 720a to press the pressing member 740, the pressing damper 750 may press the second part case 720b. The second part case 720b may receive pressure distributed by the pressing damper 750.

The pressing damper 750 may have a circular ring shape, although not limited thereto. A center hole of the ring shape may be defined to correspond to the guide boss space 727S.

The pressing damper 750 may accommodate the guide boss space 727S.

The pressing damper 750 may have a ring shape. Accordingly, the pressing damper 750 may have a shape corresponding to a cross section of the pressing member 740 to evenly distribute pressure of the pressing member 740, although not limited thereto. However, the pressing damper 750 may have a shape corresponding to or extended from the cross section of the pressing member 740.

The pressing damper 750 may have a sponge material. Accordingly, the pressing damper 750 may absorb or disperse an impact caused by the pressing member 740, although not limited thereto. However, the pressing damper 750 may have a material that absorbs an impact. For example, the pressing damper 750 may have a rubber material.

The pressing damper 750 may be formed by a rubber molding method.

FIG. 18 is a cross-sectional perspective view showing a cross section of the sensor module 700 of the food waste disposer 1 shown in FIG. 16.

The sensor module 700 according to an embodiment of the disclosure will be described in more detail with reference to FIG. 18.

The water level sensor 710 may be positioned inside the first case 720.

The first case 720 may include a water level sensor (710) mounting portion 726 that protrudes inwardly to guide a position at which the water level sensor 710 is inserted.

The water level sensor (710) mounting portion 726 may form a space corresponding to the water level sensor 710 such that the first case 720 is located at a preset position during a process of inserting the water level sensor 710 into the first case 720. The water level sensor 710 may be accommodated in the space defined to correspond to the water level sensor 710 by the water level sensor (710) mounting portion 726.

The second case 730 may be coupled to the first case 720. The first case 720 may be coupled to the second case 730 in such a way as to be movable relative to the second case 730. The first case 720 may be movable toward the accommodation direction D1 or the separation direction D2 with respect to the second case 730.

The first case 720 may include the first part case 720a where an opening configured to accommodate an accommodation sensor is defined. The first case 720 may include the second part case 720b that covers the opening defined in the first part case 720a.

The second part case 720b may include the extension hook 723 and the coupling hook 724 configured to be coupled to the first part case 720a. Accordingly, the first part case 720a and the second part case 720b may be coupled with each other while being limited in moving.

The second part case 720b may include the slit protrusion 725 to be slidingly coupled to the first case 720. While the slit protrusion 725 moves in the accommodation direction D1 or the separation direction D2 within the guide slit 732H defined in the first case 720, the second part case 720b may move in the accommodation direction D1 or the separation direction D2. While the second part case 720b moves in the accommodation direction D1 or the separation direction D2, the first part case 720a may move in the accommodation direction D1 or the separation direction D2.

The second case 730 may include an accommodation guide protrusion 736. The accommodation guide protrusion 736 may be a component that interacts with the guide boss space 727S to prevent the second part case 720b from deviating from a preset path.

The accommodation guide protrusion 736 may be accommodated in a space for the guide boss space 727S, defined in the center area of the guide boss space 727S. The guide boss space 727S may surround at least a portion of the accommodation guide protrusion 736.

The space for the guide boss space 727S may be defined such that the accommodation guide protrusion 736 is movable therein. Accordingly, while the first case 720 moves in the accommodation space D1 or the separation space D2, the accommodation guide protrusion 736 may be prevented from contacting the guide boss space 727S. However, in the case where the first case 720 significantly deviates from the preset path, the accommodation guide protrusion 736 may come into contact with the guide boss space 727S to prevent the path deviation of the first case 720.

The accommodation guide protrusion 736 may be positioned in a center portion of the second case 730. In the case in which the accommodation guide protrusion 736 is spaced away from the center portion of the second case 730, the accommodation guide protrusion 736 may easily contact, when path deviation of the first case 720 occurs at a position that is away from the accommodation guide protrusion 736, the guide boss space 727S to limit a movement of the first case 720. However, the disclosure is not limited thereto, and the accommodation guide protrusion 736 may be positioned not to easily contact the guide boss space 727S despite a movement of the first case 720.

The accommodation guide protrusion 736 may protrude toward the second part case main body 722.

The second case 730 may include a pressing guide rib 738. The pressing guide rib 738 may be a component that prevents the pressing member 740 from deviating from a preset position in the second case 730.

The pressing guide rib 738 may protrude from an inner surface of the second case main body 731 toward the second part case 720b.

The pressing member 740 may be inserted into the pressing guide rib 738 and coupled to the second case 730.

The pressing guide rib 738 may include a first pressing guide rib 738a configured to guide the pressing member 740 at an outer side of the pressing member 740.

The pressing guide rib 738 may include a second pressing guide rib 738b configured to guide the pressing member 740 at an inner side of the pressing member 740.

The pressing member 740 may be positioned between the first pressing guide rib 738a and the second pressing guide rib 738b. The pressing member 740 may be accommodated in a space between the first pressing guide rib 738a and the second pressing guide rib 738b.

The pressing member 740 may press the first case 720 in the separation direction D2. The pressing member 740 may press the second part case 720b of the first case 720. The pressing member 740 may press the inner surface of the second case 730 and press the second part case 720b by the reaction.

The pressing damper 750 may be configured to enable the pressing member 740 to evenly press the second part case 720b. In the case in which there is no pressing damper 750, pressure from the pressing member 740 may be concentrated on an area of the second part case 720b, resulting in non-uniform pressurization and generation of noise.

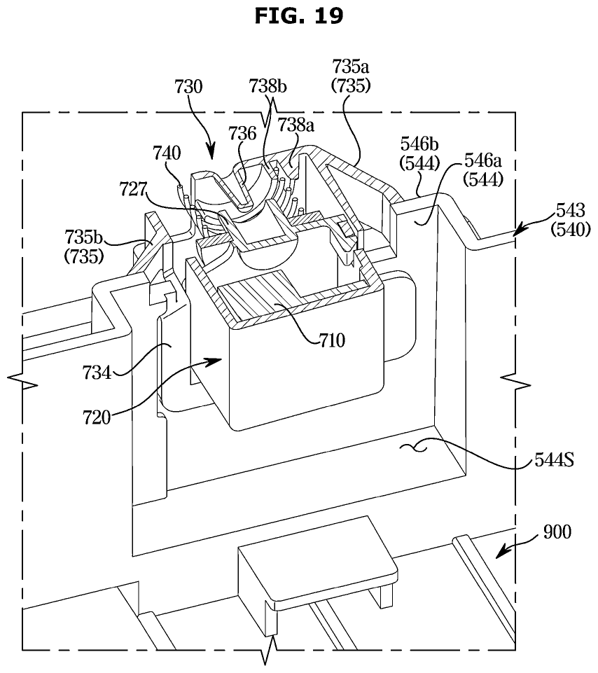

FIG. 19 is a perspective view showing a state in which the sensor module 700 of the food waste disposer 1 shown in FIG. 16 is installed in the water storage housing 540.

Coupling of the sensor module 700 according to an embodiment of the disclosure with the water storage housing 540 will be described with reference to FIG. 19.

The sensor module 700 may be coupled to the water storage housing 540. The sensor module 700 may be coupled to the water housing opposing housing wall 543 of the housing 10.

The sensor module 700 may be coupled to the opposing housing wall 543 through the accommodating opening 540A (see FIG. 13) of the water storage housing 540. The sensor module 700 may be coupled to the opposing housing wall 543 in the accommodation direction D1.

The sensor module 700 may be coupled to the opposing housing wall 543 by passing through the module inserting hole 544H (see FIG. 14) defined in the module inserting portion 544H. The sensor module 700 may be positioned such that the first case 720 in which the water level sensor 710 is installed faces the water storage container 530. Accordingly, while the water storage container 530 is located at the accommodation position, the water level sensor 710 may be positioned closer to the water storage container 530.

The supporting flange portion 734 of the sensor module 700 may be supported by the opposing housing wall 543. While the sensor module 700 moves in the accommodation direction D1, the supporting flange portion 734 may come in contact with the opposing housing wall 543. The supporting flange portion 734 may come in contact with the module inserting portion 544H (see FIG. 14). Accordingly, the sensor module 700 may be prevented from moving toward the front direction. The sensor module 700 may be prevented from being separated from the water storage housing 540 in the accommodation direction D1.

The opposing housing wall 543 may have a first opposing housing surface 546a defined to face the water storage container 530. The opposing housing wall 543 may have a second opposing housing wall 543 that is opposite to a first opposing housing wall 543.

That is, the water storage housing 540 may have the first opposing housing surface 546a that faces the water storage container 530 while the water storage container 530 is at the accommodation position. The water storage housing 540 may have a second opposing housing surface 546b that is opposite to the first opposing housing surface 546a.

The supporting flange portion 734 may be bent from the second case main body 731.

The supporting flange portion 734 may be in contact with the first opposing housing surface 546a.

While the sensor module 700 moves in the accommodation direction D1, the supporting protrusion 735 may move by penetrating the protrusion inserting hole 545H. The supporting protrusion 735 may be deformed toward the second case main body 731 and restored to pass through the protrusion inserting hole 545H.

The supporting protrusion 735 of the sensor module 700 may be supported by the opposing housing wall 543. According to the sensor module 700 being installed in the module inserting portion 544H, the supporting protrusion 745 may be in contact with the opposing housing wall 543. The supporting protrusion 735 of the sensor module 700 may be in contact with the second opposing housing surface 546b. Accordingly, the sensor module 700 may be prevented from moving toward the rear direction.

The supporting protrusion 735 may extend from the second case main body 731 and support the second opposing housing surface 546b.

The sensor module 700 may be coupled to the water storage housing 540 in such a way as to be limited from moving in the front direction by the supporting flange portion 734 and limited from moving in the rear direction by the supporting protrusion 735.

A module coupling portion may retract in the accommodation direction D1. Accordingly, while the water storage container 530 is located at the accommodation position, the first case 720 of the sensor module 700 may move in the accommodation direction D1 by a preset value. Accordingly, the water level sensor 710 may move toward the water storage container 530.

Hereinafter, a case in which the water storage container 530 moves from the separation position to the accommodation position will be described. First, a case in which the water storage container 530 is at the separation position will be described.

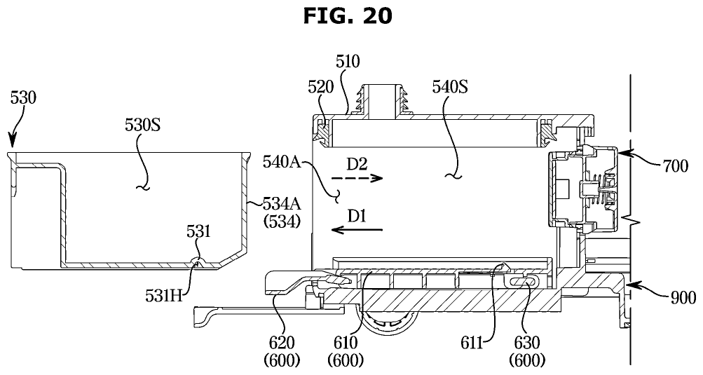

FIG. 20 is a cross-sectional view showing a state in which the water storage container 530 is separated from the water storage device 500 of the food waste disposer 1 shown in FIG. 11.

A case in which the water storage container 530 according to an embodiment of the disclosure is at the separation position will be described with reference to FIG. 20.

In the case in which the water storage container 530 is at the separation position, the water storage container 530 may be positioned outside the accommodation space 540S defined inside the water storage housing 540. The water storage container 530 may be positioned behind the accommodation space 540S.

To enable the water storage container 530 to move to the accommodation space 540S, the water storage housing door 550 may be positioned to open the accommodation opening 540A.

To enable the water storage container 530 to move to the accommodation space 540S, the locker 620 may be located at an unlocked position.

The sensor module 700 may be positioned by moving the first case 720 to the maximum toward the separation direction D2. However, even in this case, the first case 720 may be pressed toward the separation direction.

The water storage container 530 may slidingly move to the accommodation space 540S.

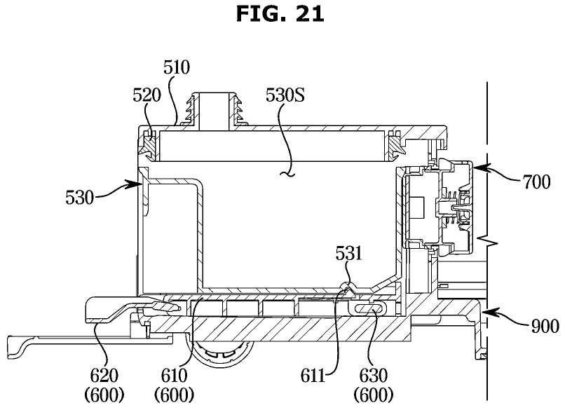

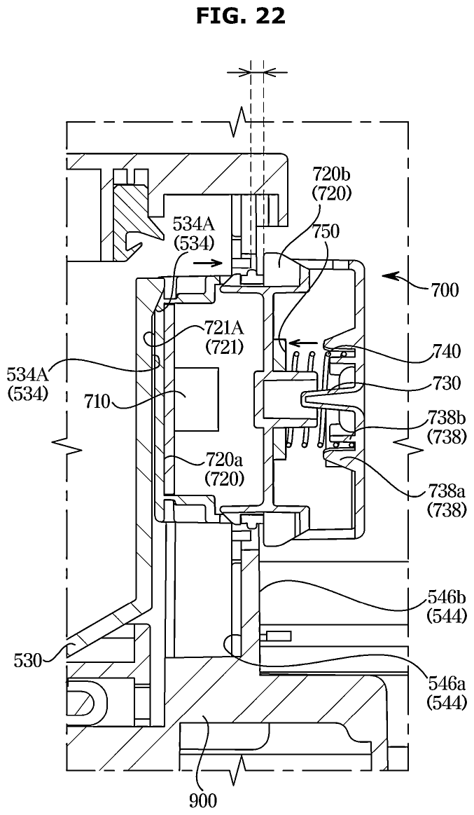

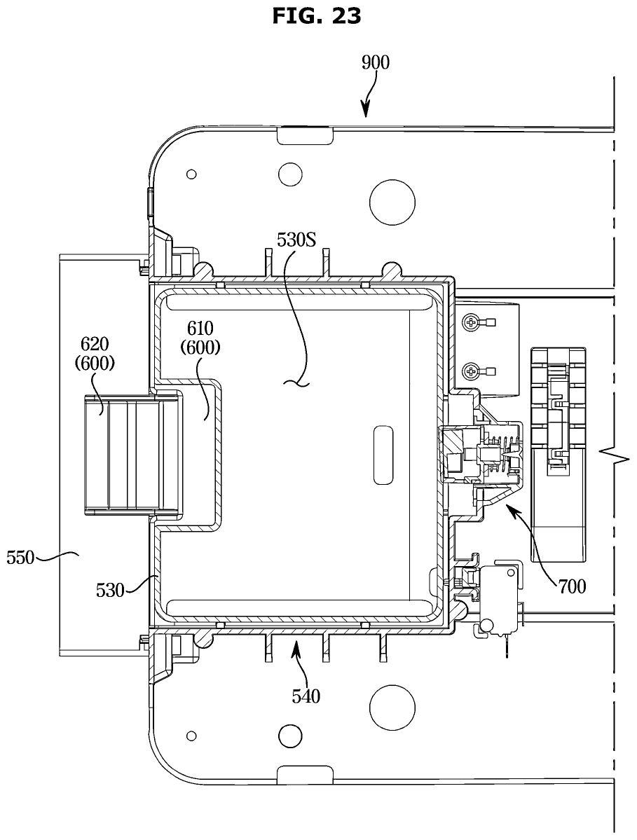

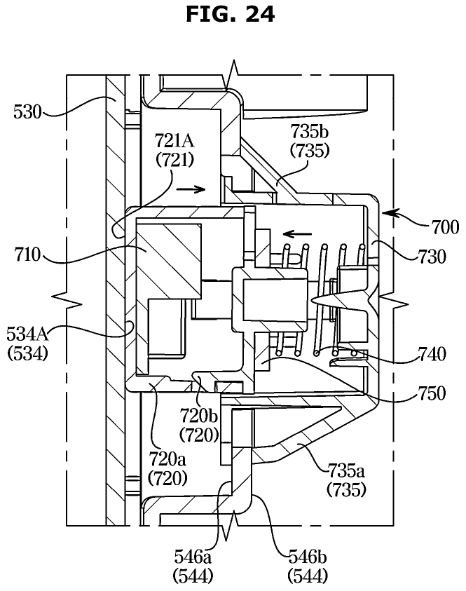

FIG. 21 is a cross-sectional view showing a state in which the water storage container 530 is accommodated in the water storage device 500 of the food waste disposer 1 shown in FIG. 20. FIG. 22 is an enlarged view of the sensor module 700 in the water storage device 500 of the food waste disposer 1 shown in FIG. 21. FIG. 23 is a cross-sectional view of the water storage device 500 of the food waste disposer 1 shown in FIG. 20, taken from another direction. FIG. 24 is an enlarged view of the sensor module 700 in the water storage device 500 of the food waste disposer 1 shown in FIG. 23.

A case in which the water storage container 530 according to an embodiment of the disclosure is at the accommodation position will be described with reference to FIGS. 21 to 24.

The water storage container 530 may move in the accommodation direction D1.

While the water storage container 530 moves in the accommodation direction D1, the stopper 611 may be accommodated in the stopper accommodating groove 531H of the stopper accommodating portion 531. While the stopper 611 is accommodated in the stopper accommodating groove 531H, the water storage container 530 may be limited in moving in the accommodation direction D1.

A position of the water storage container 530 in the case in which the stopper 611 is accommodated in the stopper accommodating groove 531H is referred to as an accommodation position.

While the water storage container 530 is located at the accommodation position, the first case 720 may be pressed in the separation direction D2 by the pressing member 740. Accordingly, the water level sensor 710 may be indirectly pressed toward the water storage container 530.

While the water level sensor 710 is pressed toward the water storage container 530, the water level sensor 710 may be located closer to the water storage container 530. Accordingly, the water level sensor 710 may more sensitively output a signal related to a change in capacitance of the water storage container 530.

In this case, the first case 720 may be pressed by the water storage container 530.

Because the second case 730 is limited in moving in the accommodation direction D1 by the supporting flange portion 734, the second case 730 may be limited in moving although the water storage container 530 moves. Accordingly, the first case 720 may be moved relatively by the second case 730.

FIG. 25 is a control block diagram showing an operation of the water level sensor 710 shown in FIG. 23.

A control by a controller 1100 according to an embodiment of the disclosure will be described with reference to FIG. 25.

The food waste disposer 1 may include the controller 1100. The controller 1100 may include a processor 1110 that performs computation and a memory 1120 that stores data.

The memory 1120 may store or memorize a program (a plurality of instructions) or data for processing a signal and providing a control signal.

The memory 1120 may include a volatile memory 1120, such as Static Random Access Memory (S-RAM) and Dynamic Random Access Memory (D-RAM), and a non-volatile memory 1120, such as Read Only Memory (ROM) and Erasable Programmable Read Only Memory (EPROM). The memory 1120 may be integrated into the processor 1110, or provided as a semiconductor device separated from the processor 1110.

The processor 1110 may further include a processing core (for example, an arithmetic circuit, a memory circuit, and a control circuit) for processing a signal and outputting a control signal based on a program or data stored in the memory 1120.

The processor 1110 may be electrically connected to the water level sensor 710. The processor 1110 may be electrically connected to the memory 1120.

The processor 1110 may obtain a water level value of the water storage container 530 based on a signal output from the water level sensor 710 in correspondence to a water level of the water storage container 530.

The food waste disposer 1 may include an output device 1200 that is controlled by a signal generated in the processor 1110. The output device 1200 may include a user interface.

The user interface may receive a touch input and output an image. The user interface may include an input button that obtains a user input, and a display that displays information about a water level of the water storage container 530 in response to a user input.

Each of the plurality of buttons may obtain a user input, and provide an electrical signal (for example, a voltage signal or a current signal) representing the obtained user input to the processor 1110.

The processor 1110 may control, based on an obtained water level value, the output device 1200 to display information about the water level value on the output device 1200.

The food waste disposer 1 may include a communication module 1300 capable of communicating with the processor 1110.

The communication module 1300 may receive data about a water level from a content source connected to a network.

The communication module 1300 may include a wired communication module 1310 that receives data about a water level by wire from a content source, and a wireless communication module 1320 that receives data about a water level wirelessly from a content source.

The wired communication module 1310 may receive a data stream from a content source by using various communication standards. For example, the wired communication module 1310 may receive data about a water level from a content source by using the Ethernet (IEEE 802.3 technology standard).

The wired communication module 1310 may include communication circuitry (for example, a wired communication interface controller) including a wired communication terminal for connecting to a network by wire, and/or the processor 1110 that modulates and/or demodulates data for wired communication, and/or the memory 1120.

The wired communication module 1320 may transmit or receive a wireless signal to or from an audio device by using various wireless communications. Also, the wired communication module 1320 may receive a data stream from a content source via the audio device.

For example, the wireless communication module 1320 may connect to a wireless repeater using Wi-Fi (IEEE 802.11 technology standard) wireless communication and receive data about a water level from a content source via the wireless repeater.

Wi-Fi wireless communication may provide direct communication (peer to peer communication) between nodes (for example, display devices and audio devices) not via a wireless repeater. In this way, direct communication using Wi-Fi wireless communication is called “WiFi P2P” or “WiFi direct.” The wireless communication module 1320 may exchange data with the audio device 200 using the Wi-Fi P2P communication standard.

In addition, the wireless communication module 1320 may exchange data with the processor 1110 by using Bluetooth (IEEE 802.15.1 technology standard) or ZigBee (IEEE 802.15.4 technology standard) wireless communication. Alternatively, the wireless communication module 1320 may exchange data with the audio device by using Near Field Communication (NFC).

The wireless communication module 1320 may include communication circuitry (for example, a wireless communication interface controller) including an antenna for transmitting and receiving a wireless signal and/or the processor 1110 for decoding/encoding data for wireless communication and/or the memory 1120.

Hereinafter, the food waste disposer 1 according to another embodiment of the disclosure will be described. In the following description about the embodiment, the same components as those shown in FIGS. 1 to 25 are assigned the same reference numerals, and descriptions thereof will be omitted.

The embodiments described in the disclosure may be implemented together to an extent that they are not in conflict with each other. The embodiments may be combined with each other or change some configurations.

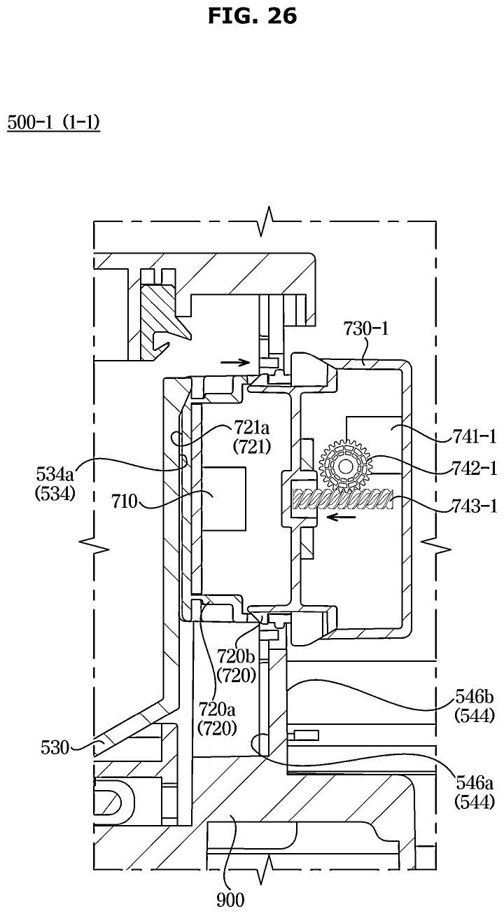

FIG. 26 is an enlarged cross-sectional view of the sensor module 700 of the food waste disposer 1-1 according to an embodiment of the disclosure.

The pressing member 740 according to an embodiment of the disclosure will be described with reference to FIG. 26.

A food waste disposer 1-1 may include the sensor module 700 including a pressing member 740. The pressing member 740 may be positioned between the first case 720 and the second case 730 and press the first case 720 toward the water storage container 530.

The pressing member 740 may include a pressing motor 741. The pressing motor 741 may be electrically connected to the processor 1110 (see FIG. 25). The processor 1110 may control an operation of the pressing motor 741-1.

The pressing motor 741-1 may include a stator (not shown) and a rotor (not shown) configured to be rotatable with respect to the stator. The rotor may be connected to a rotating shaft of the pressing motor 741-1. The rotor may rotate through magnetic interaction with the stator, and the rotation of the rotor may rotate the rotating shaft.

The pressing motor 741-1 may include, for example, a BrushLess Direct Current (BLDC) motor capable of easily controlling a rotation speed or a Permanent Magnet Synchronous Motor (PMSM).

The food waste disposer 1-1 may include a motor drive (not shown). The motor drive may receive a driving signal for rotating the rotating shaft, and supply driving current for rotating the rotating shaft of the pressing motor 741-1 to the pressing motor 741-1 based on the driving signal from the processor 1110. For example, the motor drive may receive a driving signal including a speed command of the pressing motor 741-1, and supply driving current to the pressing motor 741-1 such that a rotation speed of the pressing motor 741-1 follows the speed command.

The motor drive may provide a driving current value that is supplied to the pressing motor 741-1 and a rotation speed of the pressing motor 741-1 to the processor 1110. The processor 1110 may check a rotation of the rotating shaft based on driving current from the pressing motor 741-1. Also, the processor 1110 may identify a driving frequency of the rotating shaft based on the rotation speed of the pressing motor 741-1.

For example, in the case in which the pressing motor 741-1 is a blushless DC motor, the motor drive may supply pulse width modulated DC current to the pressing motor 741-1. In the case in which the pressing motor 741-1 is a permanent magnet synchronous motor, the motor drive may supply alternating current to the pressing motor 741-1 by using vector control.

The pressing member 740 may include a gear 742. The gear 742 may be a component for transferring power of the pressing motor 741.

The rotating shaft of the pressing motor 741 may be connected to a center of the gear 742-1. The gear 742-1 may rotate based on a rotation of the rotating shaft.

The gear 742-1 may be a spur gear, although not limited thereto. However, the gear 742-1 may be any gear 742-1 capable of transferring power of the pressing motor 741-1.

The gear 742-1 may be a metal material.

The gear 742-1 may be formed by a mold.

The pressing member 740 may include a rack 743-1. The rack 743-1 may be a component that interacts with the gear 742-1.

The rack 743-1 may be positioned to be engaged with the gear 742-1.

The gear 742-1 may rotate according to a rotation of the rotating shaft of the pressing motor 741-1. The rack 743-1 may move in the separation direction D2 or the accommodation direction D1 according to a rotation of the gear 742-1. While the rack 743-1 moves in the separation direction D2, the rack 743-1 may press the first case 720 toward the separation direction D2.

The rack 743-1 may be a metal material.

The rack 743-1 may be formed by a mold.

That is, the pressing member 740 may include the pressing motor 741-1, the gear 742-1 configured to be coupled to the rotating shaft of the pressing motor 741-1, and the rack 743-1 that is engaged with the gear 742-2 and presses the cases 720 and 730 according to a rotation of the gear 742-1.

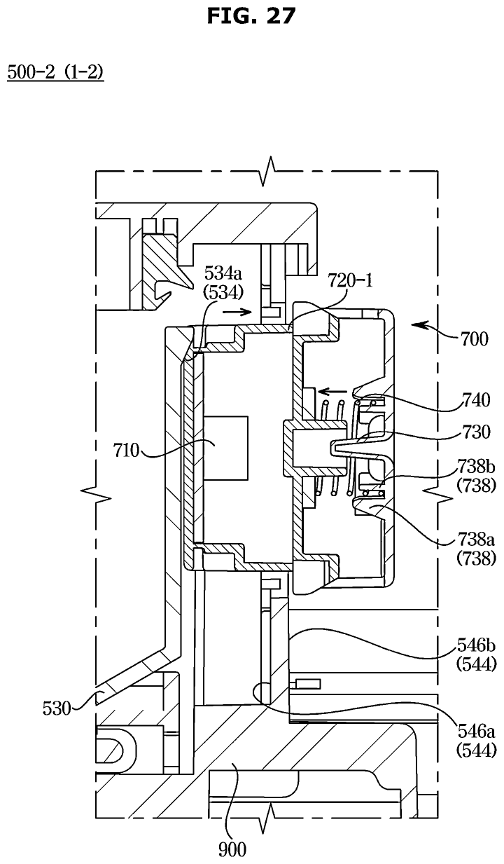

FIG. 27 is an enlarged cross-sectional view of the sensor module 700 of a food waste disposer 1-2 according to an embodiment of the disclosure.

A first case 720-2 according to an embodiment of the disclosure will be described with reference to FIG. 27.

The first part case 720a and the second part case 720b in the embodiments described with reference to FIGS. 1 to 25 may be integrated into one body. Accordingly, a production time of the first case 720-2 may be shortened. That is, the first case 720-2 may be formed as a single unit.

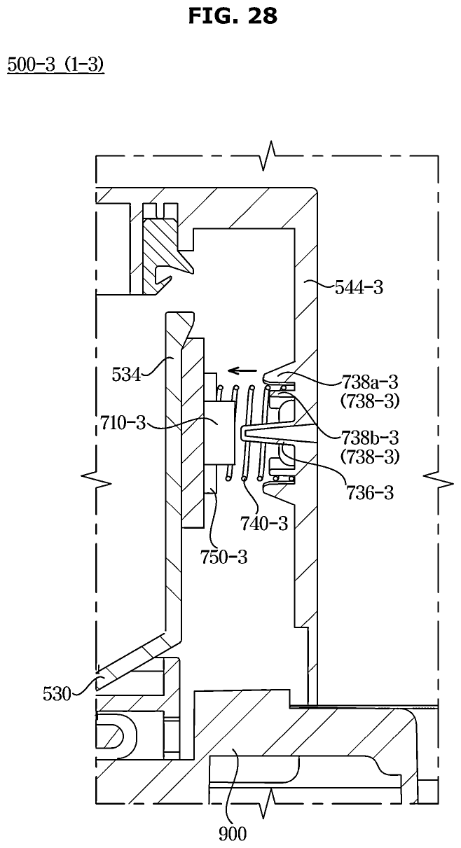

FIG. 28 is an enlarged cross-sectional view of a sensor module 700-3 of a food waste disposer 1-3 according to an embodiment of the disclosure.

The sensor module 700-3 according to an embodiment of the disclosure will be described with reference to FIG. 28.

The food waste disposer 1-3 may include the sensor module 700-3.

A water level sensor 710-3 included in the sensor module 700-3 may be positioned to be in direct contact with the opposing container wall 534 of the water storage container 530.

The sensor module 700-3 may be positioned between the opposing container wall 534 of the water storage container 530 and the opposing housing wall 543 of the water storage housing 540.

The sensor module 700-3 may include a pressing member 740-3 positioned between the water level sensor 710 and the opposing housing wall 543 of the water storage housing 540 to press the water level sensor 710 toward the water storage container 530-3.

The sensor module 700-3 may include a pressing damper 750-3 positioned between the pressing member 740-3 and the sensor module 700-3.

The sensor module 700-3 may include a pressing guide rib 738-3 positioned to guide the pressing member 740-3.

The pressing guide rib 738-3 may be positioned on the opposing housing wall 543. The pressing guide rib 738-3 may protrude from the opposing housing wall 543 toward the water level sensor 710-3.

The pressing guide rib 738-3 may be integrated into the opposing housing wall 543 of the water storage housing 540.

The pressing guide rib 738-3 may include a first pressing guide rib 738a-3 and a second pressing guide rib 738b-3.

Comparing the embodiment to the embodiments described with reference to FIGS. 1 to 25, the sensor module 400-3 may include none of the cases 720 and 730.

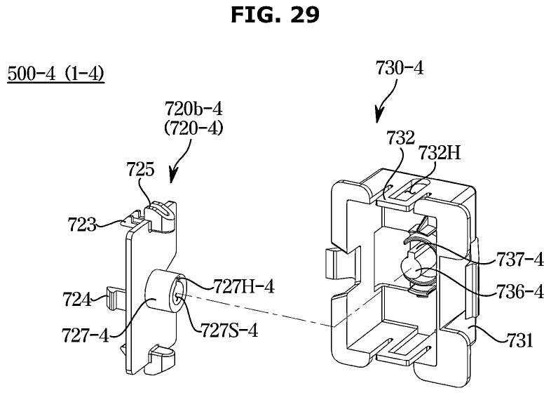

FIG. 29 is an exploded view showing a part of a first case 720-4 and a second case 730-4 of a food waste disposer 1-4 according to an embodiment of the disclosure.

A structure for guiding a movement of a sensor module 700-4 according to an embodiment of the disclosure will be described with reference to FIG. 29.

The food waste disposer 1-4 may include the sensor module 700-4 including the first case 720-4 and the second case 730-4.

The first case 720-4 may include a second part case 720b-4.

The second part case 720b-4 may include a guide boss space 727S-4 extending to an inside space of the second case 730-4.

A protrusion guide groove 727H-4 may be defined inside the guide boss space 727S-4 of the second part case 720b-4.

The protrusion guide groove 727H-4 may be positioned adjacent to an edge of the guide boss space 727S-4.

The protrusion guide groove 727H-4 may extend radially based on the guide boss space 727S-4.

The protrusion guide groove 727H-4 may extend in an extension direction of the guide boss space 727S-4.

The second case 730-4 may include an accommodation guide protrusion 736-4 to correspond to a position of the pressing member 740.

The accommodation guide protrusion 736-4 may protrude toward the guide boss space 727S-4.

The accommodation guide protrusion 736-4 may include a protrusion guide rib 737-4 protruding in a radial direction.

The protrusion guide rib 737-4 may extend in a longitudinal direction of an accommodation guide rib along the accommodation guide rib.

The protrusion guide rib 737-4 of the second case 730-4 may be accommodated in the protrusion guide groove 727H-4 defined in the second part case 720b-4. Accordingly, a movement of the protrusion guide rib 737-4 may be guided by the protrusion guide groove 727H-4. The protrusion guide rib 737-4 may be accommodated in the protrusion guide groove 727H-4 and move in the accommodation direction D1 or the separation direction D2.

The protrusion guide rib 737-4 of the second case 730-4 may correspond to the protrusion guide groove 727H-4. Accordingly, the protrusion guide rib 737-4 may be prevented from moving in other directions except for the accommodation direction D1 or the separation direction D2.

The embodiment may further include an additional component for guiding a movement of the first case 720, compared to the embodiments described with reference to FIGS. 1 to 25.

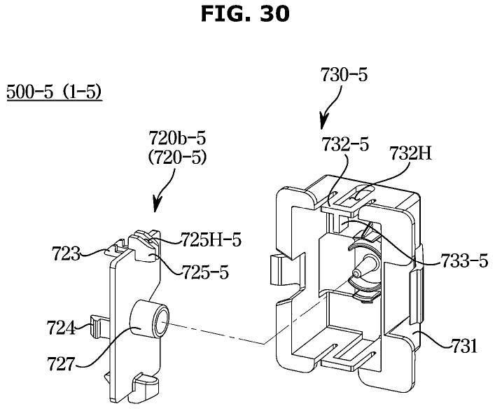

FIG. 30 is an exploded view showing a part of a first case 720-5 and a second case 730-5 of a food waste disposer 1-5 according to an embodiment of the disclosure.

A structure for guiding a movement of a sensor module 700-5 according to an embodiment of the disclosure will be described with reference to FIG. 30.

The food waste disposer 1-5 may include the sensor module 700-5 including the first case 720-5 and the second case 730-5.

The first case 720-5 may include a second part case 720b-5.

The second part case 720b-5 may include a slit protrusion 725-5 protruding outward from the second part case 720b-5.

The slit protrusion 725-5 may extend toward the second case 730. The slit protrusion 725-5 may extend in the accommodation direction D1 or the separation direction D2.

A slit guide groove 725H-5 may be defined in the slit protrusion 725-5. The slit guide groove 725H-5 may extend in the accommodation direction D1 or the separation direction D2.

The second case 730-5 may include a guide slit portion 732-5.

The second case 730-5 may include a slit guide rib 733-5 protruding from the guide slit portion 732-5 toward a space defined inside the second case 730-5.

The slit guide rib 733-5 may extend along the accommodation direction D1 or the separation direction D2.

The slit guide rib 733-5 may be accommodated in the slit guide groove 725H-5. The slit guide rib 733-5 may be accommodated in the slit guide groove 725H-5 and the slit protrusion 725-5 may move in the accommodation direction D1 or the separation direction D2. Accordingly, the slit protrusion 725 may be prevented from moving in other directions except for the accommodation direction D1 or the separation direction D2.

Slits may be defined in both sides of the guide slit portion 732-5. Accordingly, the guide slit portion 732-5 may flexibly move. The slit guide rib 733-5 protruding from one side of the guide slit portion 732-5 may move according to a movement of the guide slit portion 732-5. Accordingly, a friction between the second part case 720b-5 and the first case 720-5 may be reduced. Accordingly, the guide slit portion 732-5 may reduce noise generated while the second part case 720b-5 moves with respect to the first case 720-5.

The current embodiment may further include an additional component for guiding a movement of the first case 720, compared to the embodiments described with reference to FIGS. 1 to 25.

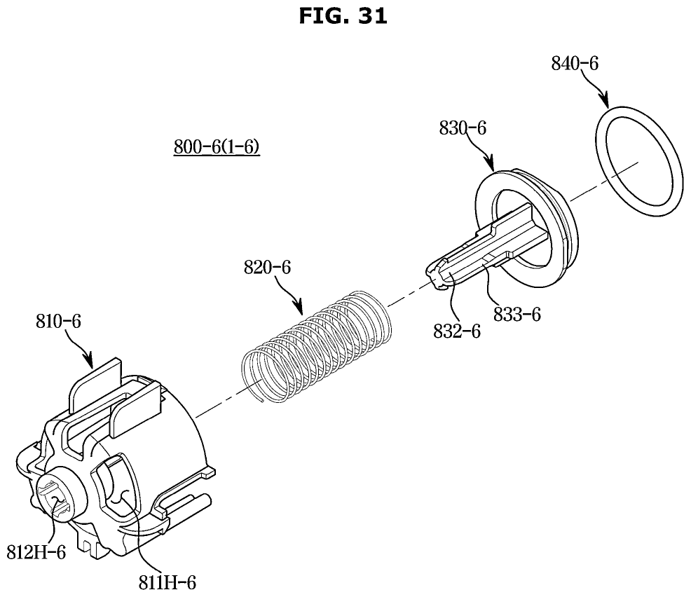

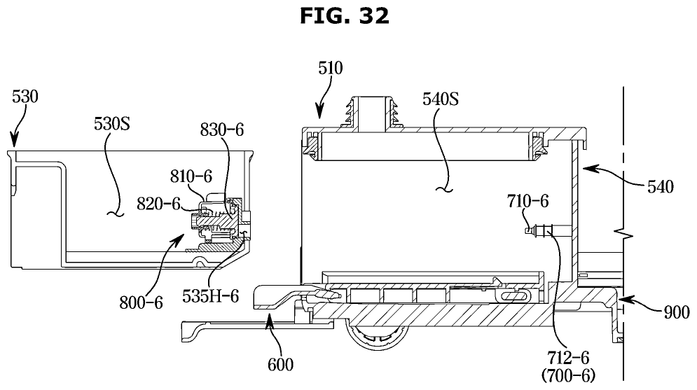

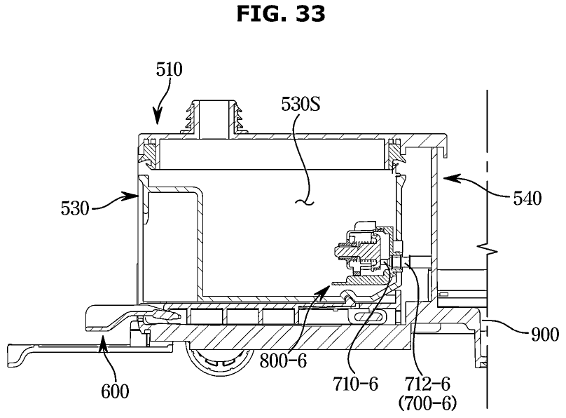

FIG. 31 is an exploded view showing a valve module 800-6 of a food waste disposer 1-6 according to an embodiment of the disclosure. FIG. 32 is a cross-sectional view showing a state in which the water storage container 530 in which the valve module 800-6 of the food waste disposer 1-6 shown in FIG. 31 is installed is located at the accommodation position. FIG. 33 is a cross-sectional view showing a state in which a water storage container 530-6 in which the valve module 800-6 of the food waste disposer 1-6 shown in FIG. 31 is installed is located at the separation position.

The valve module 800-6 included in an embodiment of the disclosure will be described with reference to FIGS. 31 to 33.

The embodiments described with reference to FIGS. 1 to 25 have been described under a main assumption that the water level sensor 710-6 does not come in contact with condensate water. The water level sensor 710-6 according to the current embodiment may be in contact with condensate water.

However, in the case in which the water level sensor 710-6 is capable of coming in contact with condensate water, the water level sensor 710-6 may be positioned to avoid a movement path of the water storage container 530 not to interfere with a movement of the water storage container 530.

To locate the water level sensor 710-6 in the water storage space 530S inside the water storage container 530, the water level sensor 710-6 may have a shape protruding downward from the water storage opening 530A. However, the water level sensor 710-6 having the shape may come in contact with the opposing container wall 534 of the water storage container 530 while the water storage container 530 moves from the accommodation position to the separation position. The water storage container 530 may be limited in moving to the outside of the cover housings 12 and 13.

The food waste disposer 1-6 may include a component for moving the water level sensor 710-6 to prevent the water level sensor 710-6 from coming in contact with the water storage container 530. However, in this case, adding a separate component for moving the water level sensor 710-6 may consume additional production cost and time.

While the water storage container 530 is at the accommodation position, the water level sensor 710-6 may penetrate the opposing container wall 534 of the water storage container 530. The water level sensor 710-6 may not limit a movement of the water storage container 530 to the accommodation position or the separation position.

However, while the water level sensor 710 penetrates the water storage container 530, it may be needed to prevent leakage of condensate water through a water storage container hole 535H-6 defined in the water storage container 530.

Particularly, as shown in FIG. 31, the food waste disposer 1-6 may include a valve module 800-6. The valve module 800-6 may be a component for preventing condensate water accommodated in the water storage container 530 from leaking out.

The valve module 800-6 may include a valve case 810-6 which forms an appearance and in which a valve case hole 810H-6 through which a detergent flows into the valve case 810-6 is formed.

The valve case 810-6 may be located inside the storage container 530 and adjacent to the water storage container hole 535H.

A water storage container valve 830-6 configured to open or close the water storage container hole 535H-6 may be provided in a rear portion of the valve case 810-6.

A movement of the water storage container valve 830-6 may be guided by the valve case 810-6.

The water level sensor 710-6 may be inserted into the water storage container hole 535H-6.

The water level sensor 710-6 may protrude to be inserted into or taken out of the water storage container 530 through the water storage container hole 535H.

The water storage container valve 830-6 may move into the water storage space 530S to prevent condensate water from leaking through the water storage container hole 535H-6. Accordingly, the water storage container hole 535H-6 may be opened or closed.

The water storage container valve 830-6 may cover the water storage container hole 535H-6.

The water storage container valve 830-6 may be provided with a valve pressing portion 831 which the water level sensor 710-6 is capable of pressing.

The water storage container valve 830-6 may include a valve guide protrusion 832-6 protruding to extend by penetrating a front center of the valve case 810-6 from a center of the pressing portion.

The water storage container valve 830-6 may include a valve guide rib 833-6 protruding radially from the valve guide protrusion 832-6 to prevent the water storage container valve 830-6 from rotating. The valve guide rib 833-6 may extend in a longitudinal direction of the valve guide protrusion 832-6.

A valve protrusion groove 812H-6 may be defined in the front center of the valve case 810-6. The valve protrusion groove 812H-6 may be provided to correspond to cross-sectional shapes of the valve guide protrusion 832-6 and the valve guide rib 833-6.

The valve module 800-6 may include a valve elastic member 820 that elastically biases the water storage container valve 830-6 to the water storage container hole 535H-6. The valve elastic member 820-6 may surround the valve guide protrusion 832-6 and the valve guide rib 833-6. The valve elastic member 820-6 may press an inner surface of the valve case 810-6 and the valve pressing portion 831-6 of the water storage container valve 830-6.

The valve elastic member 820-6 may be positioned between the valve case 810-6 and the water storage container valve 830-6 to be compressible.

The valve module 800-6 may include a valve sealing member 840-6 coupled to be adjacent to an edge of the valve pressing portion 831-6 of the water storage container valve 830-6 and configured to seal between the water storage container valve 830-6 and the water storage container hole 535H-6.

The valve sealing member 840-6 may seal between the water storage container hole 535H-6 and the water storage container valve 830-6.

Particularly, as shown in FIGS. 32 and 33, while the water storage container 530 moves from the separation position to the accommodation position, the water level sensor 710-6 may press the water storage container valve 830-6 and simultaneously move by penetrating the water storage container hole 535H-6.

The sensor module 700-6 may include a module sealing member 712-6 to prevent condensate water from leaking between the water storage container hole 535H-6 and the water level sensor 710-6 while the water level sensor 710-6 passes through the water storage container hole 535H-6.

The module sealing member 712-6 may correspond to the water storage container hole 535H-6.

The module sealing member 712-6 may have an elastic material.

While the water storage container 530 is at the accommodation position, the water level sensor 710-6 may space the water storage container valve 830-6 from the water storage container hole 535H-6. At the same time, the valve sealing member 840-6 may be spaced from the water storage container hole 535H-6.

Condensate water may move toward the water level sensor 710 through the valve case hole 810H-6. The water level sensor 710-6 may come in contact with the condensate water and output a signal corresponding to a water level of the condensate water.

At the same time, condensate water accommodated in the water storage container 530 may be prevented from leaking out of the water storage container 530.

So far, specific embodiments have been shown and described, however, the disclosure is not limited to these embodiments. It should be interpreted that various modifications may be made by one of ordinary skill in the technical art to which the disclosure belongs, without deviating from the gist of the technical concept of the disclosure, which is defined in the following claims.

1. A food waste disposer comprising:
a cover housing;
a disposal device configured to accommodate food waste while positioned in the cover housing;
an exhaust pipe configured to be connected to the disposal device to guide air containing moisture;
a water storage container configured to collect condensate water in the exhaust pipe, the water storage container being separable from the cover housing;
a water storage housing to accommodate the water storage container; and
a sensor module, including a water level sensor coupleable to the water storage housing while the water storage container is accommodated in the water storage housing, and while the sensor module is coupled to the water storage housing, the water level sensor is configured to output, based on the water level sensor being located adjacent to the water storage container, a signal related to a water level of the condensate water collected in the water storage container,
wherein the water level sensor is configured to detect the water level of the condensate water in the water storage container by contacting with the water storage container, while the water storage container is accommodated in the cover housing.

2. The food waste disposer of claim 1, wherein the water storage container is movable between
an accommodation position at which the water storage container is positioned inside the cover housing and is in contact with the sensor module; and
a separation position at which the water storage container is positioned outside the cover housing and the water storage container is separated from the cover housing.

3. The food waste disposer of claim 2, wherein
a water storage space to accommodate the condensate water is defined in the water storage container, and
the water level sensor is, while the water storage container is located at the accommodation position, prevented from being located in the water storage space.

4. The food waste disposer of claim 3, wherein
the water storage container comprises an opposing container surface facing the sensor module while the water storage container is located at the accommodation position, and
the sensor module comprises an opposing module surface facing the opposing container surface and corresponding to the opposing container surface such that the sensor module is in close contact with the water storage container while the water storage container is located at the accommodation position.

5. The food waste disposer of claim 2, wherein
the sensor module further comprises a pressing member configured to press the water level sensor in a direction toward the water storage container while the water storage container is located at the accommodation position.

6. The food waste disposer of claim 5, wherein
the sensor module comprises a case in which the water level sensor is positioned, and
the pressing member is configured to indirectly press the water level sensor in the direction toward the water storage container by pressing the case while the water storage container is located at the accommodation position.

7. The food waste disposer of claim 5, wherein
the sensor module further comprises:
a first case in which the water level sensor is positioned; and
a second case being coupleable to the water storage housing,
wherein while the first case is coupled to the second case, the first case is moveable forward and backward relative to the second case.

8. The food waste disposer of claim 7, wherein
the pressing member is positioned between the first case and the second case and configured to elastically support the first case in the direction toward the water storage container by being compressed while the water storage container is located at the accommodation position.

9. The food waste disposer of claim 7, wherein, while the water storage container moves in an accommodation direction from the separation position toward the accommodation position, the first case moves to a position of the second case spaced in the accommodation direction from a position of the first case.

10. The food waste disposer of claim 8, wherein
the first case comprises:
a first part case including an opening in which the water level sensor is rested; and
a second part case detachably coupled to the first part case and configured to prevent the water level sensor from being detached from the first part case.

11. The food waste disposer of claim 7, wherein
the water storage housing comprises a first opposing housing surface facing the water storage container while the water storage container is located at the accommodation position, and a second opposing housing surface which is opposite to the first opposing housing surface, and
the second case comprises:
a second case main body;
a supporting flange portion bent from the second case main body and being in contact with the first opposing housing surface; and
a supporting protrusion extending from the second case main body and supporting the second opposing housing surface.

12. The food waste disposer of claim 7, wherein
a guide slit extending in a direction from the separation position of the water storage container toward the accommodation position is defined in the second case, and
the first case comprises a slit protrusion of which at least a portion is accommodated in the guide slit to be guided by the guide slit.

13. The food waste disposer of claim 7, wherein the sensor module further comprises a pressing damper positioned between the first case and the pressing member and configured to evenly distribute pressure applied to the first case by the pressing member.

14. The food waste disposer of claim 1, further comprising:
a heating device configured to heat the disposal device to evaporate moisture of food waste accommodated in the disposal device; and
an exhaust fan coupled to the exhaust pipe and configured to move air containing moisture in the disposal device to the exhaust pipe.

15. The food waste disposer of claim 1, wherein
the water storage container is positioned in a direction of gravity with respect to the exhaust pipe such that condensate water generated in the exhaust pipe is collected.
